(19) United States
(12) Patent Application Publication
(10) Pub. No.: US 2026/0228233 A1
(43) Pub. Date: Aug. 6, 2026

(54) SYSTEM AND METHODS FOR ONE OR MORE UNIVERSAL LANGUAGE MODELS WITH DATA INTEGRATION AND OUTPUT GENERATION

(71) Applicant: State Farm Mutual Automobile Insurance Company, Bloomington, IL (US)

(72) Inventors: Aaron WILLIAMS, Congerville, IL (US); Ross WHEELER, Scottsdale, AZ (US)

(73) Assignee: State Farm Mutual Automobile Insurance Company, Bloomington, IL (US)

(21) Appl. No.: 19/062,798

(22) Filed: Feb. 25, 2025

Related U.S. Application Data
(60) Provisional application No. 63/754,006, filed on Feb. 5, 2025.

(51) Int. Cl. G06F 16/248; G06F 40/20

(52) U.S. Cl. CPC G06F 16/248; G06F 40/20

(57) ABSTRACT

Systems and methods for dynamically generating output in response to user input through interconnected data retrieval and processing are disclosed. The method may include, such as by processor(s), transceiver(s), and/or sensor(s): (1) receiving a request from a device; (2) utilizing a LLM to process the request to determine a request purpose; (3) transmitting data corresponding to the request purpose to a RAG model; (4) receiving relevant data associated with the request purpose from the RAG model, the RAG model retrieves relevant data based upon user-defined configurations from (i) LLM, (ii) SLMs, (iii) dynamic data stream(s) associated with interconnected system(s), and/or (iv) generative software system(s); (5) transmitting the relevant data to a LLM data deconfliction model; (6) utilizing the LLM data deconfliction model to reconcile, filter, or resolve conflicting or redundant information of the relevant data; and/or (7) generating the output using the generative software system(s).

### CROSS-REFERENCE TO RELATED APPLICATION

This patent application claims the benefit of priority to U.S. Provisional Application No. 63/754,006, filed on Feb. 5, 2025, the entirety of which is incorporated herein by reference.

### TECHNICAL FIELD

This present disclosure relates generally to the field of artificial intelligence (AI) and data processing systems. In particular, the present disclosure relates to methods and systems for enhancing large language models (LLMs) through the integration of retrieval augmented generation (RAG) and advanced data deconfliction mechanisms.

### BACKGROUND

Large language models (LLMs) may face several technical challenges that limit the LLM's effectiveness. While the LLMs may possess broad knowledge across various topics, the LLM's responses may suffer from inaccuracies due to outdated training data. Although LLMs may be enhanced with retrieval augmented generation (RAG) to incorporate user-provided data, the effectiveness of RAG may be constrained by the limited scope of user-uploaded or accessible materials. This limitation may be further exacerbated by novice users who may not know how to provide comprehensive data sources. Additionally, RAG solutions may rely upon overly large datasets that may risk information conflicts, reducing overall accuracy as the LLM struggles to reconcile discrepancies. These solutions may also lack access to dynamic, real-time data streams from over-the-air integrations, such as those from software-defined vehicles, smart homes, IoT devices, and interconnected databases, which may limit the LLM's ability to provide up-to-date and deeply contextualized insights.

Moreover, conventional LLMs are typically designed to function as standalone systems, unable to collaborate effectively with other LLMs or small language models (SLMs), which may limit the capacity to provide holistic and interdisciplinary solutions. The outputs may be often restricted to basic formats, such as plain text, and may fail to leverage advanced tools for generating diverse outputs. These challenges may collectively restrict the depth, specificity, versatility, and practical application of LLMs, preventing the LLMs from fully meeting the evolving needs of complex, real-world use cases. Conventional LLMs may include other ineffectiveness, encumbrances, inefficiencies, and drawbacks, as well.

### SUMMARY

The present embodiments may relate, inter alia, to a universal language model ecosystem with integrated data orchestration and output generation capabilities, such as those discussed herein. Specifically, the present computer systems and computer-implemented methods may solve technical challenges by enabling seamless interconnection between a primary LLM and a plurality of SLMs, user-defined inputs, live web-crawling data, connected integrations (e.g., smart devices, software-defined vehicles), and generative output tools. The system leverages RAG to retrieve and supplement the LLM with relevant, up-to-date and context-specific data, while addressing data conflicts through a LLM data deconfliction model to enhance solution accuracy, depth, and adaptability.

In one aspect, a computer-implemented method for dynamically generating output through artificial intelligence (AI) driven data retrieval, processing, and contextual analysis of interconnected data sources may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another and operate as input and/or output devices. In one instance, the computer-implemented method may be performed by one or more local or remote processors of a computing system in communication with one or more local or remote data sources.

The computer-implemented method may include, via one or more local or remote processors, transceivers, sensors, servers, and/or other components: (1) receiving, by the one or more processors, a request from a user device, wherein the request includes a specified task or a query; (2) utilizing, by the one or more processors, a large language model (LLM) to process the request to determine a request purpose; (3) transmitting, by the one or more processors, data corresponding to the request purpose to a retrieval augmented generation (RAG) model; (4) receiving, by the one or more processors, relevant data associated with the request purpose from the RAG model, wherein the RAG model communicates with one or more agent-based AI systems to identify the relevant data from (i) the LLM, (ii) one or more small language models (SLMs), (iii) one or more dynamic data streams associated with one or more interconnected systems, and/or (iv) one or more generative software systems; (5) transmitting, by the one or more processors, the relevant data to a LLM data deconfliction model; (6) utilizing, by the one or more processors, the LLM data deconfliction model to processes the relevant data to reconcile, filter, or resolve conflicting or redundant information of the relevant data; (7) generating, by the one or more processors, the output based upon the relevant data, wherein the output is dynamically generated using the one or more generative software systems; and/or (8) outputting, by the one or more processors, the output to a user interface of the user device. The method may include additional, less, or alternate functionality, including that discussed elsewhere herein.

In another aspect, a computer system for dynamically generating output through artificial intelligence (AI) driven data retrieval, processing, and contextual analysis of interconnected data sources may be provided. The computer system may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer system may be performed by one or more local or remote processors of a computing system in communication with one or more local or remote data sources, and at least one non-transitory computer readable medium storing instructions which, when executed by the one or more processors, cause the one or more processors to perform certain operations.

The computer system may include, via one or more processors, non-transitory computer readable medium, transceivers, sensors, servers, and/or other components to perform operations that may include: (1) receiving a request from a user device, wherein the request includes a specified task or a query; (2) utilizing a large language model (LLM) to process the request to determine a request purpose; (3) transmitting data corresponding to the request purpose to a retrieval augmented generation (RAG) model; (4) receiving relevant data associated with the request purpose from the RAG model, wherein the RAG model communicates with one or more agent-based AI systems to identify the relevant data from (i) the LLM, (ii) one or more small language models (SLMs), (iii) one or more dynamic data streams associated with one or more interconnected systems, and/or (iv) one or more generative software systems; (5) transmitting the relevant data to a LLM data deconfliction model; (6) utilizing the LLM data deconfliction model to processes the relevant data to reconcile, filter, or resolve conflicting or redundant information of the relevant data; (7) generating the output based upon the relevant data, wherein the output is dynamically generated using the one or more generative software systems; and/or (8)outputting the output to a user interface of the user device. The system may include additional, less, or alternate functionality, including that discussed elsewhere herein.

In yet another aspect, a non-transitory computer readable medium for dynamically generating output through artificial intelligence (AI) driven data retrieval, processing, and contextual analysis of interconnected data sources may be provided. The non-transitory computer readable medium may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the non-transitory computer readable medium may be performed by one or more local or remote processors of a computing system in communication with one or more local or remote data sources, and at least one non-transitory computer readable medium storing instructions which, when executed by the one or more processors, cause the one or more processors to perform certain operations.

The non-transitory computer readable medium may include, via one or more processors, transceivers, sensors, servers, and/or other components: (1) receiving a request from a user device, wherein the request includes a specified task or a query; (2) utilizing a large language model (LLM) to process the request to determine a request purpose; (3) transmitting data corresponding to the request purpose to a retrieval augmented generation (RAG) model; (4) receiving relevant data associated with the request purpose from the RAG model, wherein the RAG model communicates with one or more agent-based AI systems to identify the relevant data from (i) the LLM, (ii) one or more small language models (SLMs), (iii) one or more dynamic data streams associated with one or more interconnected systems, and/or (iv) one or more generative software systems; (5) transmitting the relevant data to a LLM data deconfliction model; (6) utilizing the LLM data deconfliction model to processes the relevant data to reconcile, filter, or resolve conflicting or redundant information of the relevant data; (7) generating the output based upon the relevant data, wherein the output is dynamically generated using the one or more generative software systems; and/or (8) outputting the output to a user interface of the user device. The operations may include additional, less, or alternate functionality, including that discussed elsewhere herein.

In one aspect, a computer-implemented method for dynamically generating output in response to user input through interconnected data retrieval and processing may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another and operate as input and/or output devices. In one instance, the computer-implemented method may be performed by one or more local or remote processors of a computing system in communication with one or more local or remote data sources.

The computer-implemented method may include, via one or more local or remote processors, transceivers, sensors, servers, and/or other components: (1) receiving, by the one or more processors, a request from a user device, wherein the request includes a specified task or a query; (2) utilizing, by the one or more processors, a large language model (LLM) to process the request to determine a request purpose; (3) transmitting, by the one or more processors, data corresponding to the request purpose to a retrieval augmented generation (RAG) model; (4) receiving, by the one or more processors, relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, and/or (iv) one or more generative software systems; (5) transmitting, by the one or more processors, the relevant data to a LLM data deconfliction model; (6) utilizing, by the one or more processors, the LLM data deconfliction model to processes the relevant data to reconcile, filter, or resolve conflicting or redundant information of the relevant data; (7) generating, by the one or more processors, the output based upon the relevant data, wherein the output is dynamically generated using the one or more generative software systems; and/or (8) outputting, by the one or more processors, the output to a user interface of the user device. The method may include additional, less, or alternate functionality, including that discussed elsewhere herein.

In another aspect, a computer system for dynamically generating output in response to user input through interconnected data retrieval and processing may be provided. The computer system may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer system may be performed by one or more local or remote processors of a computing system in communication with one or more local or remote data sources, and at least one non-transitory computer readable medium storing instructions which, when executed by the one or more processors, cause the one or more processors to perform certain operations.

The computer system may include, via one or more processors, non-transitory computer readable medium, transceivers, sensors, servers, and/or other components to perform operations that may include: (1) receiving a request from a user device, wherein the request includes a specified task or a query; (2) utilizing a large language model (LLM) to process the request to determine a request purpose; (3) transmitting data corresponding to the request purpose to a retrieval augmented generation (RAG) model; (4) receiving relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, and/or (iv) one or more generative software systems; (5) transmitting the relevant data to a LLM data deconfliction model; (6) utilizing the LLM data deconfliction model to processes the relevant data to reconcile, filter, or resolve conflicting or redundant information of the relevant data; (7) generating the output based upon the relevant data, wherein the output is dynamically generated using the one or more generative software systems; and/or (8) outputting the output to a user interface of the user device. The system may include additional, less, or alternate functionality, including that discussed elsewhere herein.

In yet another aspect, a non-transitory computer readable medium for dynamically generating output in response to user input through interconnected data retrieval and processing may be provided. The non-transitory computer readable medium may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the non-transitory computer readable medium may be performed by one or more local or remote processors of a computing system in communication with one or more local or remote data sources, and at least one non-transitory computer readable medium storing instructions which, when executed by the one or more processors, cause the one or more processors to perform certain operations.

The non-transitory computer readable medium may include, via one or more processors, transceivers, sensors, servers, and/or other components: (1) receiving a request from a user device, wherein the request includes a specified task or a query; (2) utilizing a large language model (LLM) to process the request to determine a request purpose; (3) transmitting data corresponding to the request purpose to a retrieval augmented generation (RAG) model; (4) receiving relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, and/or (iv) one or more generative software systems; (5) transmitting the relevant data to a LLM data deconfliction model; (6) utilizing the LLM data deconfliction model to processes the relevant data to reconcile, filter, or resolve conflicting or redundant information of the relevant data; (7) generating the output based upon the relevant data, wherein the output is dynamically generated using the one or more generative software systems; and/or (8) outputting the output to a user interface of the user device. The operations may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts a universal language model and integrated data orchestration ecosystem for retrieving, reconciling, and generating contextually relevant outputs by leveraging LLMs, SLMs, RAG, agent-based AI, live web crawling, interconnected integrations, and user-defined inputs, according to certain aspects of the disclosure.

FIG. 2A is a diagram that illustrates a content generation workflow for generating customized social media posts based upon user-defined inputs, RAG, SLMs, integrated real-time data streams, and multimodal generative output tools, according to certain aspects of the disclosure.

FIG. 2B is a diagram that illustrates a multi-source data retrieval and processing ecosystem for property health assessment based upon user-defined inputs, RAG, SLMs, integrated real-time data streams, and multimodal generative output tools, according to certain aspects of the disclosure.

FIG. 3 is a diagram that illustrates an agentic AI that automatically selects data sources, integrations, and output generation tools for content generation, according to certain aspects of the disclosure.

FIG. 4 is a diagram that illustrates an automated, agent-based AI that generates enterprise and departmental strategies, goals, and deliverables, according to certain aspects of the disclosure.

FIG. 5 is an exemplary flowchart of a computer-implemented or computer-based process for dynamically generating output through AI-driven data retrieval, processing, and contextual analysis of interconnected data sources, according to certain aspects of the disclosure.

FIG. 6 is an exemplary flowchart of a computer-implemented or computer-based process for dynamically generating output in response to user input through interconnected data retrieval and processing, according to certain aspects of the disclosure.

FIG. 7 shows an exemplary machine-learning training flow chart, according to one or more embodiments.

FIG. 8 illustrates an implementation of an exemplary computer system that executes one or more techniques presented herein.

Advantages will become more apparent to those skilled in the art from the following description of the preferred embodiments that have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

Large language models (LLM) may possess extensive general knowledge spanning a wide variety of topics, enabling the LLMs to provide in-depth answers and solutions upon nearly any subject. However, the accuracy of these responses may vary significantly due to inherent limitations. One primary challenge may include hallucination, where the model may generate information that may appear plausible but is factually incorrect or unverifiable. Additionally, the reliance upon static training data may indicate that a LLM's knowledge base may become outdated over time, making the LLM less effective at addressing queries needing the most current or specialized information. As a result, while LLMs are powerful tools for generating responses, the LLM's reliability may depend upon the quality and recency of the underlying data, necessitating supplementary mechanisms to ensure accuracy and relevance.

Retrieval augmented generation (RAG) may significantly enhance the functionality of LLMs by enabling the users to upload or reference external documents, PDFs, images, or any number of files and data sources. This supplemental data may allow the LLMs to deliver more specific, contextually relevant, and accurate responses tailored to the user's query. By incorporating information directly provided by the user, RAG may effectively bridge gaps in the LLM's training data, ensuring that answers are grounded in the specific details of the uploaded or referenced materials. However, the effectiveness of RAG may be inherently dependent upon the user's ability to identify and provide high-quality and relevant data sources. For novice users or those with limited access to comprehensive datasets, this process may lead to gaps in the information provided, ultimately constraining the accuracy and utility of the outputs.

Furthermore, existing RAG solutions may be limited in the RAG solution's score and integration capabilities. The RAG solutions may primarily rely upon static inputs provided by users and may lack mechanisms to incorporate dynamic, real-time data streams, such as over-the-air integrations from software-defined vehicles, smart home systems, IoT devices, interconnected databases, or other specialized data ecosystems. Attempting to build a RAG system upon a vast dataset without effective reconciliation mechanisms may introduce the risk of conflicting information, further undermining the accuracy of the solutions. Without robust methods to filter, prioritize, and/or reconcile such data, the system's ability to provide detailed and reliable responses may diminish. As a result, while RAG solutions may enhance LLM performance, the RAG solutions current limitation may prevent them from achieving the depth, precision, and/or adaptability required for more complex, dynamic, or interconnected use cases.

The result of these described limitations may be a reliance upon static, non-live source material and training data that may lack depth and may fail to encompass a wide range of highly specific, up-to-date knowledge. This narrow scope may often restrict the LLM to expertise in a single subject area, preventing the LLM from thinking beyond that domain. Consequently, the LLM may struggle to provide holistic, multidisciplinary perspectives or solutions that may need integrating knowledge from diverse fields. Additionally, this constraint may inhibit the ability of the LLM to collaborate effectively with other LLMs or small language models (SLMs), further reducing its potential to deliver comprehensive and innovative outputs.

Furthermore, the LLM may be constrained to generating solutions in basic formats, such as plain text, without leveraging the capabilities of more advanced tools. This limitation may prevent the integration of diverse and sophisticated outputs, such as AI-generated media, code development, creation of SLMs, immersive 3D environments, or outputs tailored for productivity software (e.g., PowerPoint, Excel, etc.). As a result, the LLM's potential to deliver comprehensive, multifaceted solutions across a broader range of applications may remain significantly underutilized.

### Exemplary System Architecture for a Universal Language Model and Integrated Data Orchestration Ecosystem

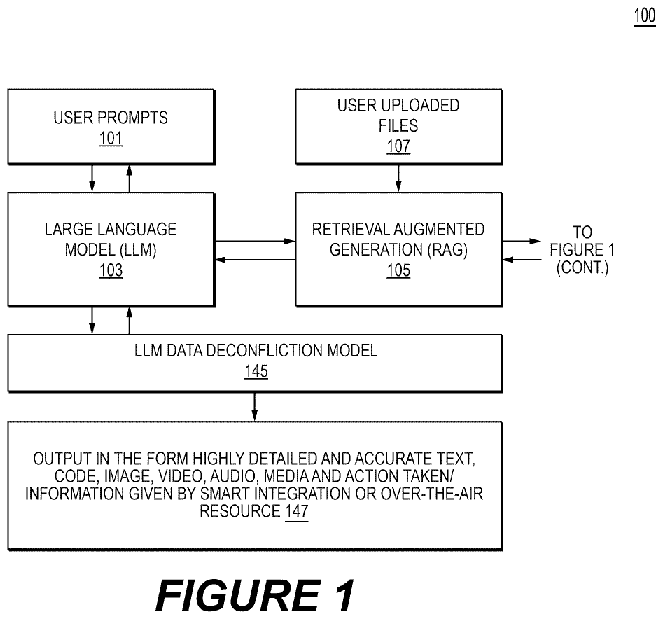

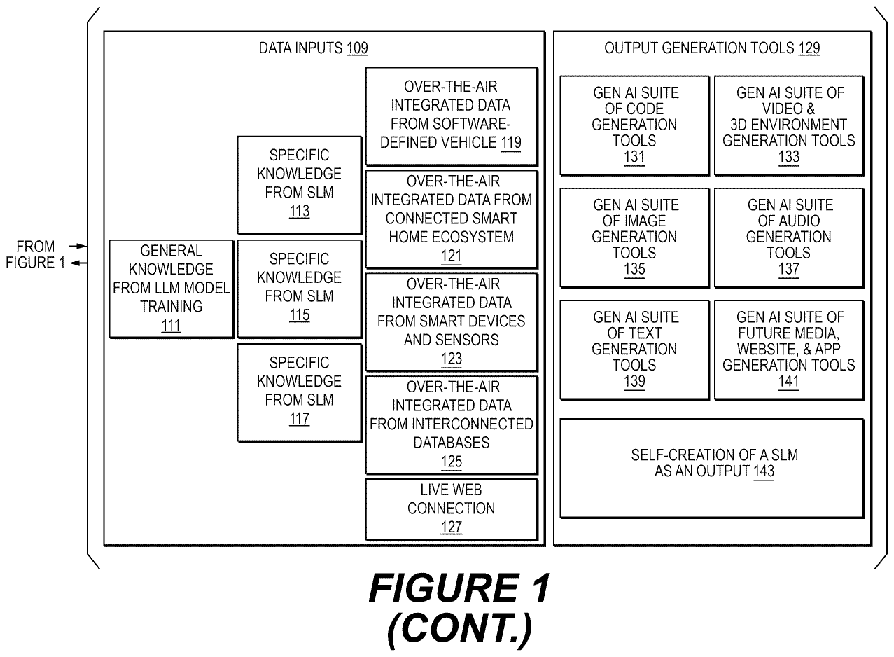

To address technical challenges, such as the above, computing system 100 of FIG. 1 may integrate a multi-layered data orchestration framework. This framework may utilize a primary LLM alongside SLMs, real-time web crawling, connected integrations (e.g., smart devices, software-defined vehicles, sensors), and user-provided data sources to gather and supplement relevant information. The computing system 100 may incorporate a robust LLM data deconfliction model that may identify and resolve data conflicts, consolidating redundant information while ensuring accuracy and consistency. Additionally, the computing system 100 may leverage agent-based AI for automated data and output selection, enabling dynamic adaptability to user queries and evolving requirements. By combining these components, the computing system 100 may ensure enhanced accuracy, depth of response, and the ability to generate diverse, tailored outputs across a variety of contexts.

The computing system 100 may facilitate a seamless interconnection between the LLM and various specialized components. The LLM, trained to possess broad, general knowledge across multiple subjects, may utilize RAG to access and incorporate data from multiple SLMs, each of which may be trained upon a specific area of expertise (e.g., business, personal financial accounts and financial strategy, social media content, a user's small business, or any other targeted data category or focus area defined by the user). In addition, to leverage the specialized knowledge from SLMs, the computing system 100 may integrate supplemental user-provided sources, such as uploaded files, images, videos, documents, presentations, or manuals, as well as dynamic inputs from connected devices, connected environments, or connected vehicles. By drawing upon these diverse data sources and integrating with selected free or paid generative output tools, the computing system 100 may solve complex user prompts and deliver tailored, multifaceted outputs across a wide range of applications.

The result may include an orchestrated, interconnected data retrieval and output ecosystem that may leverage a primary LLM to access data from a single, specific source, a selected group of sources, or an ecosystem of topic-specific SLMs and other connected LLMs. This ecosystem may incorporate over-the-air integrations (e.g., smart home devices and sensors, software-defined vehicle data, smart sensors, smart devices, and user accounts) and user-provided uploads or inputs. By enabling the use of curated, context-specific training data, the computing system 100 may enhance LLM accuracy, deliver deeper and more detailed responses, and support a wide range of generative outputs tailored to user needs.

In addition to incorporating SLMs, the computing system 100 may integrate a live web-crawling capability to provide up-to-date information that may not be included in the LLM's training data. This may ensure that the computing system 100 leverages the specialized expertise of the SLMs, the latest information from the web, and the broad, general knowledge and orchestration capabilities of the LLM, creating a comprehensive and dynamic solution ecosystem.

Additionally, the primary LLM may access other public or subscription based LLMs through API calls, enabling it to retrieve information from these non-primary LLMs. This retrieved information may be incorporated as additional context to enhance the accuracy and depth of the outputs generated in response to the original prompts.

In one instance, users may manually specify and select specific language models, integrations, and additional inputs to tailor the computing system 100's response to the user's needs. In another instance, the selection process may be automated through the use of an artificial intelligence (AI) agent. The AI agent, leveraging the ongoing conversation between the user and the primary LLM, may determine the most appropriate language models, connected integrations, data inputs, and generative output tools needed to address the user's specific prompts. The AI agent may adapt to modified user requests or outputs, dynamically curating relevant knowledge sources, integrations, and training data to provide precise, context-aware responses and deliver outputs optimized for the user's needs. This dual approach may ensure flexibility and efficiency, thereby allowing users to maintain control over customization when needed, while also leveraging automation to streamline the selection process, adapt to evolving inputs, and deliver highly accurate, context-aware responses tailored to the user's specific needs.

Once inputs are received by the primary LLM, the LLM data deconfliction model may identify similarities or conflicts across the multiple data inputs. This layer may clarify and consolidate redundant information to ensure the output is both efficient and accurate. In cases where conflicting data cannot be automatically resolved, the LLM data deconfliction model may prompt the LLM and the user for clarification or a solution. Once resolved, the solution may be stored as a learned rule for future reference, unless modified later. After resolving conflicts, the consolidated data may flow back through the LLM data deconfliction model for final validation before proceeding to the generation of outputs. Accordingly, the computing system 100 may enhance the accuracy, consistency, and efficiency of outputs by ensuring that conflicting or redundant information is resolved and streamlined before final production.

FIG. 1 depicts a universal language model and integrated data orchestration ecosystem for retrieving, reconciling, and generating contextually relevant outputs by leveraging LLMs, SLMs, RAG, agent-based AI, live web crawling, interconnected integrations, and user-defined inputs, according to certain aspects of the disclosure. FIG. 1 may include the computing system 100 that may include user prompts 101, LLM 103, RAG 105, user uploaded files 107, data inputs 109, output generation tools 129, and/or LLM data deconfliction model 145. It should be understood that other implementations of computing system 100 may omit one or more of the foregoing components and/or may include additional components, as the case may be.

In one instance, a user may submit the user prompt 101 to LLM 103. The user prompt 101 may include a user-generated input that may take various forms, such as a question, a request for specific information, a command to generate content (e.g., text, code, images, or video), or an instruction for performing a task. In one example, the user prompt 101 may be simple like “summarize this document,” or complex as “generate a financial analysis based upon the provided balance sheet.” The user prompt 101 may be interactive, where the user iteratively refines the prompt based upon previous responses. The user may submit the user prompt 101 through an interactive interface of a device (e.g., hand-held computers, desktop computers, laptop computers, wireless communication devices, cell phones, smartphones, mobile communications devices, a Personal Communication System (PCS) device, tablets, server computers, gateway computers, or any combination thereof, including the accessories and peripherals of these devices, or any combination thereof).

In one instance, the LLM 103 may include a machine-learning model trained upon vast amounts of data (e.g., textual data) to understand, generate, and process the human language. The LLM 103 may leverage deep learning techniques to predict and generate text based upon patterns learned from extensive datasets. The LLM 103 may process broad, general knowledge across multiple domains and may generate responses to a wide range of prompts, from answering factual questions to composing creative content.

The LLM 103 may process the user prompt 101 by analyzing its intent, context, and structure. The LLM 103 may perform text comprehension, content generation, contextual reasoning, and/or multi-turn dialogue processing. The LLM 103 may parse and interpret natural language queries, enabling them to extract relevant information, summarize lengthy documents, and perform sentiment analysis. The LLM 103 may engage in an iterative dialogue with the user, requesting clarifications or additional details to refine its understanding of the user prompt 101. Additionally, the LLM 103 may exhibit contextual reasoning by recognizing patterns in text, drawing logical inferences, and responding appropriately based upon prior interactions in a conversation.

As previously discussed, the accuracy of the LLM 103 may be influenced by the quality and scope of the training data, and the LLM 103 may sometimes produce hallucinations responses that sound plausible but are factually incorrect. Hence, the LLM 103 may integrate with the RAG 105, SLMs (e.g., SLMs 113, 115, and 117), and real-time data sources (e.g., over-the-air integrated data), to enhance accuracy and relevance. When connected to external data sources, such as live web crawlers, proprietary databases, or API-based integrations, the LLM 103 may retrieve up-to-date information beyond the training data. The LLM 103 may also work with the LLM data deconfliction model 145 to filter redundant or conflicting information, thereby ensuring that outputs remain coherent and reliable. This adaptability makes the LLM 103 valuable in various applications, including research, business intelligence, customer service, and software development. For example, the LLM 103 may also serve as a powerful content-generation tool, capable of generating code, composing stories, and producing structured outputs like reports or scripts.

In one instance, the RAG 105 may enhance the accuracy and relevance of responses generated by the LLM 103 by incorporating external knowledge sources. Unlike conventional LLMs that may rely solely upon pre-trained data, the RAG 105 may dynamically retrieve relevant information from external databases, documents, structured repositories, or live web sources to supplement the responses by the LLM 103. This retrieval mechanism may help mitigate common issues with the LLM 103, such as outdated training data and hallucinations, by grounding outputs in verifiable and contextually rich information. By integrating retrieval and generation, the RAG 105 may significantly improve the precision, depth, and accuracy of the responses by the LLM 103.

The RAG 105 may operate through a dual-stage process: retrieval and generation. In the retrieval phase, the RAG 105 may analyze the user prompts 101 and determine the most relevant external data sources. These sources may include structured datasets, proprietary knowledge bases, APIs, and/or indexed documents. The retrieved data may be fed into the generation phase, where the LLM 103 may synthesize and contextualize the information to produce a coherent and informative response. This process may enable the LLM 103 to provide more domain-specific and up-to-date answers while reducing reliance upon generalized, pre-trained knowledge. Additionally, the RAG 105 may be fine-tuned to prioritize certain sources or filter retrieved content based upon predefined criteria, ensuring that outputs align with user-defined accuracy and relevance standards. The RAG 105 may enhance decision-making and problem-solving by combining dynamic data retrieval with real-time generative capabilities.

In one example, the LLM 103 may process the user prompts 101, identify the core purpose of the request, and communicate this information to the RAG 105. The RAG 105 may integrate external data sources and specialized knowledge, and retrieve relevant data from these sources, which may include SLMs, live data streams, and user-provided inputs. The RAG 105 may utilize these external resources to provide highly specific and contextually relevant information, supplementing the general knowledge of the LLM 103. The feedback loop between the LLM 103 and the RAG 105 may ensure that the generated response are not only contextually accurate but also informed by the most up-to-date and specialized data, thus optimizing the overall output quality.

In one instance, the user uploaded files 107 may be directly fed into the RAG 105, where they serve as additional data sources to enhance the context and specificity of responses. The user uploaded files 107 may include documents, images, videos, presentations, and/or other relevant formats, which may be processed and integrated into the RAG 105's knowledge base. Then, the RAG 105 may retrieve pertinent information from these user uploaded files 107 and combine the pertinent information with data from other sources, such as SLMs and live web crawls, to generate more accurate and contextually relevant outputs. This bidirectional exchange may ensure that the RAG 105 continually accesses and updates its data pool, improving the accuracy and precision of the generated results.

In one instance, the data inputs 109 may encompass a diverse range of information sources, including structured and unstructured data or real-time data stream, all of which may contribute to enriching the ability of the computing system 100 to generate accurate and contextually relevant outputs in response to user queries. The data inputs 109 may include LLM model training 111, SLMs (e.g., SLMs 113, 115, and 117), and over-the-air integrated data from various sources (e.g., software-defined vehicles 119, connected smart home ecosystem 121, smart devices and sensors 123, interconnected databases 125), and live web connection 127. It should be understood that other implementations of the data inputs 109 may omit one or more of the foregoing components and/or may include additional components, as the case may be.

In one instance, the LLM model training 111 may refer to the vast amount of information the model has learned during its pre-training phase, which may span a wide array of topics, domains, and contexts. As a result, the LLM may understand and generate responses across various subject matters, offering insights into general topics, common facts, and broad concepts. This general knowledge may serve as the foundation base for the LLM's ability to process and understand user inputs, but for more specific or timely information, abdominal data sources or SLMs may be accessed.

In one instance, the SLMs (e.g., SLMs 113, 115, and 117) may enhance the performance and accuracy of the RAG 105. The SLMs may be specifically designed to focus upon a single area of expertise. For example, SLMs may be trained with data that is deeply relevant to a particular field (e.g., insurance, finance, healthcare, etc.). By leveraging this highly targeted knowledge, the SLMs may provide precise, nuanced answers that may be difficult for a general purpose LLM to produce. SLMs may be valuable for applications that may need deep, subject-specific insight, ensuring that users receive responses with the highest degree of accuracy and reliability. In the context of the RAG system, the SLMs may function by contributing domain-specific knowledge when a user request may need expertise beyond the general scope of the primary LLM. The SLMs may be integrated into the data retrieval pipeline to supplement the information provided by the LLM, offering specialized context that may strengthen the quality of the final output. For example, when a user queries a tax document, a SLM trained upon tax language and concepts may provide relevant and accurate insights, helping to refine and focus the response.

In one instance, the software-defined vehicle 119 may include real-time data through embedded sensors, telematics systems, and/or AI-driven control units. Over-the-air integration may allow seamless data transmission from these vehicles to external systems, enabling the retrieval of critical insights such as vehicle diagnostics, driving behavior, energy consumption, and/or maintenance needs. This data may be leveraged in various applications, including predictive maintenance, fleet optimization, autonomous driving enhancements, and/or personalized in-car experiences.

In one instance, the connected smart home ecosystem 121 may include interconnected devices, such as smart thermostats, security cameras, lighting controls, voice assistants, and/or energy management systems. Over-the-air integration may enable the continuous synchronization of data across these devices, allowing the computing system 100 to analyze user behaviors, predict preferences, and automate home management tasks. By incorporating smart home data, users may receive personalized insights, improve energy efficiency, enhance security, and/or optimize daily routines.

In one instance, the smart devices and sensors 123 may be deployed across various environments (e.g., wearable health monitors, industrial automation system) and may continuously collect and transmit data over-the-air. This real-time data exchange may allow the computing system 100 to monitor system performance, detect anomalies, and generate predictive insights. By integrating over-the-air data from these devices, the computing system 100 may provide proactive recommendations and improve decision-making.

In one instance, the interconnected database 125 may facilitate the seamless sharing of structured and unstructured data across multiple systems, enabling the processing of datasets in real-time. Over-the-air integration may allow databases from different industries to interconnect securely, providing the computing system 100 with enriched contextual information. By leveraging over-the-air data from the interconnected databases 125, the computing system 100 may deliver more accurate and context-aware insights.

In one instance, a live web connection 127 may serve as a dynamic data input source that may enable real-time access to the most up-to-date information available online. Unlike static training datasets, which may become outdated over time, a live web connection may continuously retrieve fresh data, ensuring that responses remain current and relevant. By integrating a live web connection into the RAG framework, the computing system 100 may supplement the knowledge base with the latest facts, statistics, and evolving insights. Additionally, when combined with LLM and SLMs, the live web connection 127 may enhance the ability of the computing system 100 to provide well-rounded, accurate, and contextually relevant responses by cross-referencing multiple trusted sources in real-time.

In one instance, the output generation tools 129 may leverage generative AI to produce customized responses, transforming processed data into meaningful outputs tailored to user needs. The output generation tools 129 may include various generative AI tools (e.g., code generation tools 131, video and 3D environment generation tools 133, image generation tools 135, audio generation tools 137, text generation tools 139, and future media, website, and app generation tools) and a self-creation of a SLM as an output 143. It should be understood that other implementations of the output generation tools 129 may omit one or more of the foregoing components and/or may include additional components, as the case may be.

In one instance, the code generation tools 131 may generate, refine, and optimize software codes based upon specific prompts. These tools may assist with a variety of coding tasks, including writing scripts, debugging refactoring, and generating full-scale applications in multiple programming languages. By leveraging AI-driven code generation, the computing system 100 may automate repetitive coding tasks, reduce development time, and enhance software quality.

In one instance, the video and 3D environment generation tools 133 may create, edit, and/or enhance dynamic multimedia content. These tools may provide AI-assisted capabilities, such as automated video editing, text-to-video generation, scene composition, and 3D modeling with realistic textures. Whether for gaming, virtual reality simulations, digital marketing, or entertainment, the video and 3D environment generation tools 133 may generate high-quality media with minimal manual interventions.

In one instance, the image generation tools 135 may generate, modify, and/or enhance images. These tools may offer capabilities, such as text-to-image synthesis, style transfer, image upscaling, object removal, and/or artistic rendering. The users may specify image attributes, such as resolution, color palette, and/or artistic style, ensuring tailored outputs that align with specific use cases.

In one instance, the audio generation tools 137 may create, modify, and synthesize audio content. The audio generation tools 137 may generate human-like voiceovers, background music, sound effects, and/or adaptive soundscapes based upon textual or contextual inputs. Furthermore, the audio generation tools 137 may incorporate advanced features, such as multilingual voice generation, emotion-based tone adjustment, and/or real-time audio manipulation.

In one instance, the text generation tools 139 may provide advanced writing, summarization, and content enhancement capabilities. The text generation tools 139 may assist with drafting (e.g., articles, legal documents, etc.) and conversational AI responses. By leveraging natural language processing (NLP) models, the computing system 100 may ensure readability and contextual accuracy in the generated texts.

In one instance, the future media, website, and app generation tools 141 may automate the development of interactive digital experiences. The future media, website, and app generation tools 141 may enable rapid website prototyping, AI-assisted UI/UX design, automated front-end and back-end development, and/or application deployment.

In one instance, the self-creation of a SLM as an output 143 may enable users to define specific parameters, such as domain focus and dataset scope to tailor the SLM to their unique requirements. Once the parameters are set, the self-creation of a SLM as an output 143 may extract relevant training data from the RAG pipeline, incorporating user-provided inputs, connected integrations, and external sources. The extracted data may be preprocessed, structured, and fine-tuned to develop a SLM. The self-generated SLM may then be deployed as a standalone resource or integrated within the broader system to provide domain-specific expertise, enabling more precise and context-aware responses. Additionally, the process may allow for iterative refinement, where the user may continuously update and enhance the SLM based upon evolving data needs.

In one instance, the LLM data deconfliction model 145 may ensure that information retrieved from multiple sources is accurate, non-redundant, and contextually consistent. In complex AI-driven systems, such as those integrating RAG, LLMs, SLMs, and real-time integrations, conflicting data can arise due to variations in sources, updates, and interpretations. The LLM data deconfliction model 145 may act as an intermediary that analyzes, compares, and reconciles discrepancies before generating outputs.

The LLM data deconfliction model 145 may detect duplicate, contradictory, or inconsistent data across multiple inputs. This process may involve applying NLP, statistical analysis, and rule-based logic to identify patterns of conflict. When discrepancies occur, the LLM data deconfliction model 145 may determine whether one data source takes precedence based upon factors, such as source reliability, recency, confidence scoring, or user-defined parameters. If conflicts remain unresolved, the LLM data deconfliction model 145 may prompt the LLM, agent-based AI, and/or the user to clarify or validate the correct interpretation.

Additionally, the LLM data deconfliction model 145 may support adaptive learning by maintaining a repository of resolved conflicts. When similar conflicts reappear, the LLM data deconfliction model 145 may automatically apply previously validated resolutions unless new evidence or updates necessitate a change. This may create a feedback loop, refining the models'ability to manage data accuracy over time. By integrating a robust data deconfliction mechanism, the computing system 100 enhances efficiency and contextual precision. This may ensure that output 147 delivered to users is comprehensive, non-redundant, and free from conflicting information.

The computing system 100 may generate a highly detailed output 147 across multiple formats, ensuring that the response aligns with the user's request. Once all inputs have been processed, reconciled, and validated, the computing system 100 may generate output 147 in the form of text, code, images, video, audio, and/or other media, depending upon the nature of the query. Additionally, for environments with smart integrations or over-the-air resources, the computing system 100 may trigger actions, such as executing automated tasks, sending commands to connected devices, or retrieving and updating real-time information from IoT networks, smart sensors, or software-defined systems.

In such a manner, the computing system 100 may offer numerous benefits, including supreme data synthesis and output efficiency, ensuring that responses are generated with optimized accuracy and relevance. The computing system 100 may enable seamless interconnection between diverse data sources, allowing for enhanced subject matter resource (SMR) utilization, brainstorming, and solution generation with greater precision. The integration of over-the-air live data may ensure real-time insights in a structured and easily digestible format. Additionally, the computing system 100 may enhance response accuracy and depth, providing granular control over training data while implementing methods to regulate RAG accuracy and establish rules for resolving conflicting information. Beyond technical advantages, the computing system 100 may also introduce opportunities for licensing rights, the creation of new products, and multiple revenue streams. Furthermore, the computing system 100 may support the automated generation of SLMs in response to live prompts, dynamically ingesting and adapting to real-time data inputs for specialized applications.

### Exemplary System Architecture for Social Media Content Generation and Data Orchestration

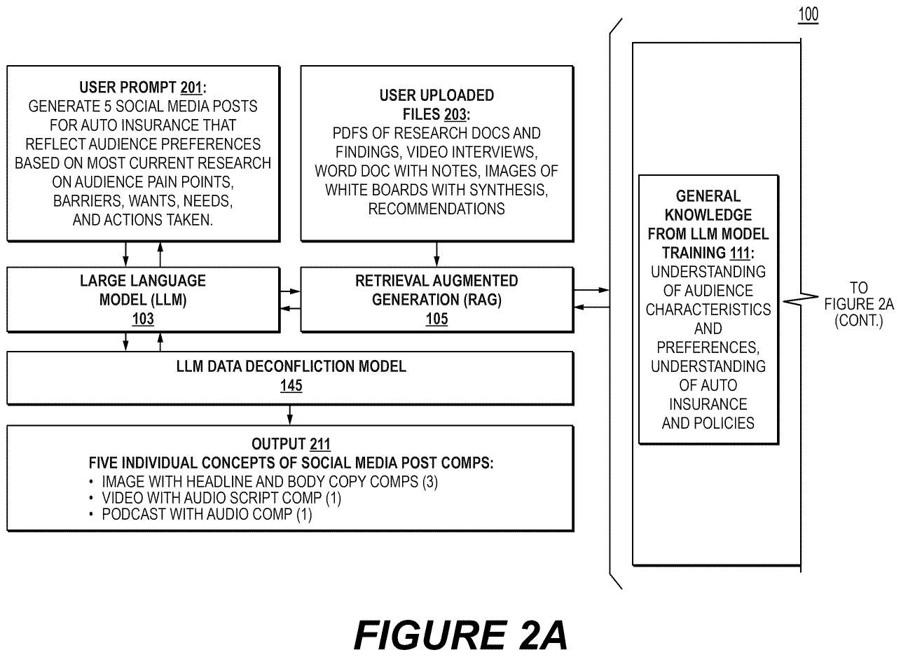

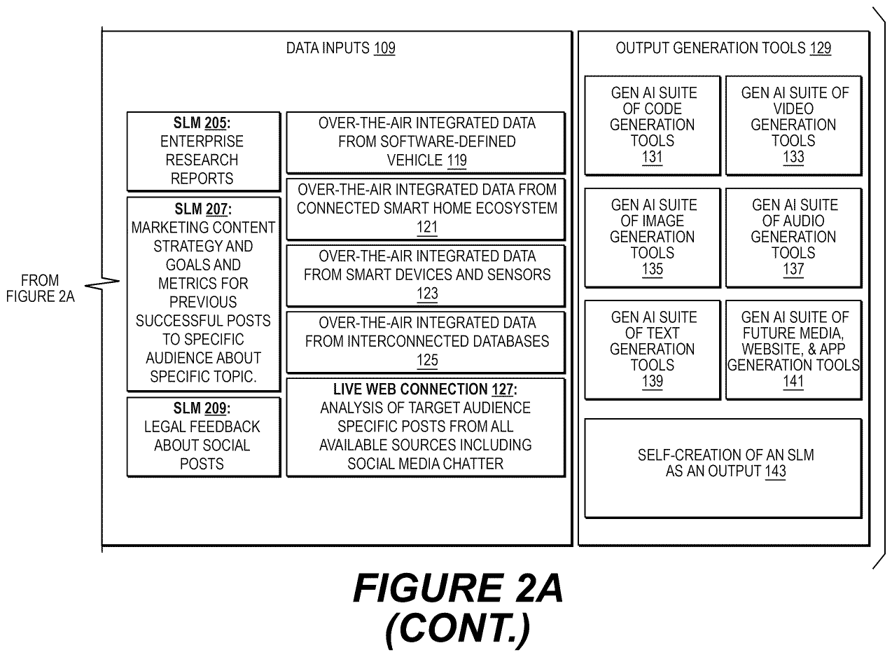

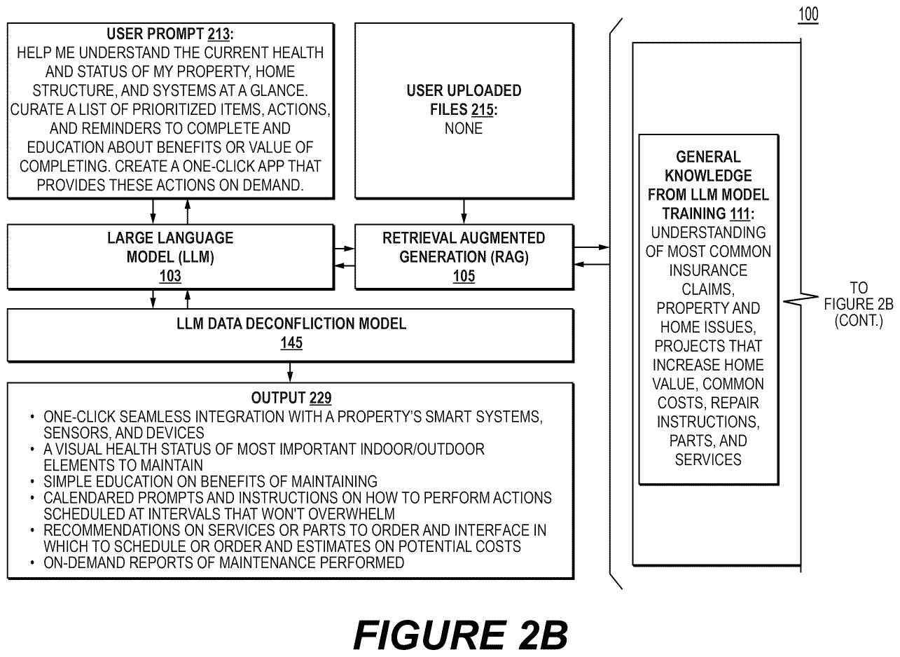

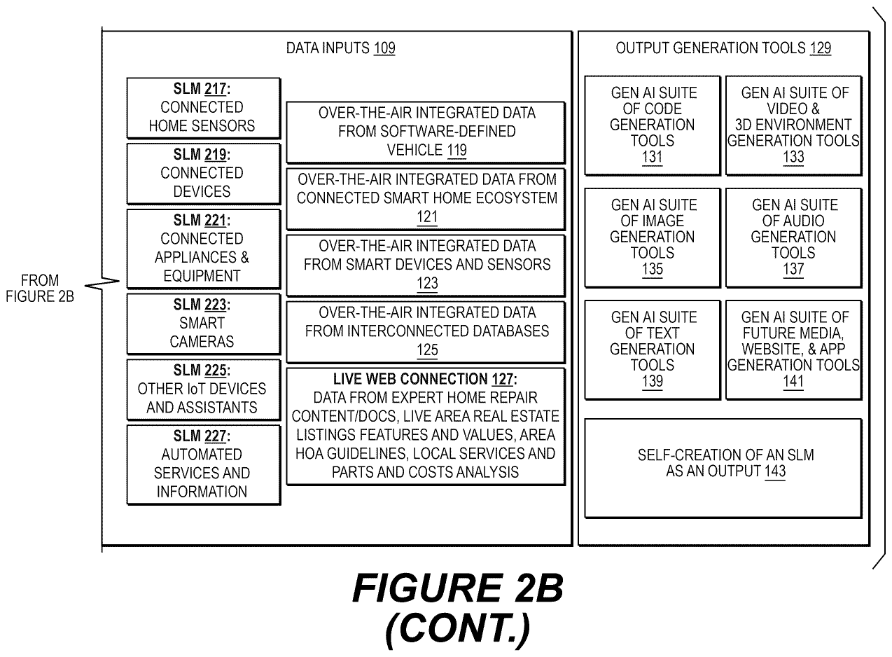

FIG. 2A is a diagram that illustrates a content generation workflow for generating customized social media posts based upon user-defined inputs, RAG, SLMs, integrated real-time data streams, and multimodal generative output tools, according to certain aspects of the disclosure. FIG. 2A retains the core structure and functional components described in FIG. 1. The elements and their interactions in FIG. 2A also follow the same fundamental design as FIG. 1. Since the components in FIG. 2A have been explained in detail in FIG. 1, the description of FIG. 2A focuses upon the additional functionalities introduced.

The process may begin when a user issues a detailed user prompt 201 requesting five social media posts related to auto insurance. The prompt may specify that these posts should reflect audience preferences, pain points, barriers, needs, and actions taken, based upon the most current research available. The user prompt 201 may be transmitted to the LLM 103, which may serve as the central orchestrator of the workflow.

Upon receiving the user prompt, the LLM 103 may communicate with the RAG 105, which may enhance the ability of the LLM 103 to provide accurate and contextually rich outputs. Unlike a standalone LLM, the RAG 105 may dynamically retrieve information from multiple structured and unstructured sources, ensuring that the generated content remains precise, up-to-date, and highly relevant.

To refine the content generation process, the RAG 105 may receive and process user-provided files, which may include one or more of:
(i) PDF reports containing audience research, industry trends, or auto insurance insights;
(ii) Transcripts of video interviews where insurance professionals or consumers discuss key issues;
(iii) Text notes in Word documents summarizing findings and recommendations; and/or
(iv) Images of whiteboards with synthesis of research data, user personas, or marketing strategies.

These user-provided inputs may ensure that the RAG 105 integrates domain-specific, proprietary, and firsthand insights into the content generation process, enriching the depth and accuracy of the outputs. The RAG 105 may expand its retrieval process by integrating data from various categories of knowledge sources.

In one instance, the RAG 105 may communicate with LLM model training 111 to access general knowledge. The RAG 105 may retrieve data pertaining to (i) audience behavior and preferences, such as demographic insights, behavioral patterns, and/or engagement trends from the LLM's pre-trained dataset, and/or (ii) auto insurance policies and industry knowledge including a structured understanding of policy types, coverage options, claims processing, and/or regulatory framework.

The RAG 105 may consult a plurality of SLMs, each trained upon specific domain expertise, to provide targeted and nuanced insights. SLM 205 may specialize in enterprise reports and may pull structured and validated insights from proprietary datasets and industry research. SLM 207 may focus upon marketing content strategy and performance metrics and may retrieve data upon past social media campaign performance, audience segmentation, and/or engagement metrics. SLM 209 may concentrate upon legal and compliance analysis and may analyze the language and phrasing of social media posts to ensure compliance with advertising regulations and consumer protection laws.

The RAG 105 may also connect to various over-the-air integrated data from live sources including:
(i) Software-defined vehicle 119: real-time vehicle telemetry, driving patterns, accident likelihood analysis, and/or policyholder driving behavior;
(ii) Connected smart home ecosystem 121: Data from IoT-enabled home security systems, weather conditions affecting vehicles, and home insurance bundling insights;
(iii) Smart devices and sensors 123: health and driving-related risk factors that may impact insurance premium or claims;
(iv) Interconnected databases 125: external repositories of vehicle insurance claims, accident reports, and/or policyholder trends; and/or
(v) Live web crawling and social media analysis: aggregate and analyze real-time social media chatter, user-generated content, sentiment analysis, and/or tending discussion upon auto insurance.

This multi-layered retrieval mechanism may ensure that the generated content reflects the latest real-world data from both proprietary and publicly available sources.

Once the data has been consolidated, the RAG 105 may interact with specialized generative tools to produce the requested content in diverse formats. These may include one or more of:
(i) Code generation tools 131 for dynamic or interactive social media experiences (e.g., chatbots, interactive posts);
(ii) Video and 3D environment generation tools 133 for creating high-quality promotional videos or virtual experiences;
(iii) Image generation tools 135 for generating visuals that align with the tone and messaging of the user request;
(iv) Audio generation tools 137 for voiceovers, podcasts, or spoken-word content;
(v) Text generation tools 139 for captions, post descriptions, and/or blog-style social content;
(vi) Future media, website, and app generation tools 141 for microsites or interactive landing pages; and/or
(vii) Self-creation of an SLM as an output 143 for generating a dedicated micro-model for a highly specialized task.

After aggregating data and generating preliminary outputs, the RAG 105 may communicate back with the primary LLM (i.e., LLM 103) to refine and optimize the final content. This step may ensure coherence, relevance, and/or alignment with the original user prompt 201.

Before finalizing the social media posts, the computing system 100 may run all retrieved and generated content through the LLM data deconfliction model 145 for (i) identifying conflicting or redundant data across multiple sources, (ii) consolidating similar information to remove duplication, (iii) validating inconsistencies by prompting the LLM 103 or the user for clarification, and/or (iv) storing conflict resolution rules as learned knowledge for future automation.

After resolving data conflicts, the computing system 100 may generate five distinct social media post compositions, including:
(i) Three image-based posts: each featuring an image, headline, and body copy tailored to audience preferences;
(ii) One video post: a dynamic visually engaging piece with accompanying audio script; and/or
(iii) An audio composition suitable for podcasts.

These outputs may be customized, multi-format, and data-driven, ensuring they are optimized for engagement, relevance, and/or strategic marketing impact.

### Exemplary System Architecture for Property Health Assessment and Automated Maintenance Recommendations

FIG. 2B is a diagram that illustrates a multi-source data retrieval and processing ecosystem for property health assessment based upon user-defined inputs, RAG, SLMs, integrated real-time data streams, and multimodal generative output tools, according to certain aspects of the disclosure. FIG. 2B retains the core structure and functional components described in FIG. 1. The elements and their interactions in FIG. 2B also follow the same fundamental design as FIG. 1. Since the components in FIG. 2B have been explained in detail in FIG. 1, the description of FIG. 2B focuses upon the additional functionalities introduced.

The process begins when users submit a user prompt 213 to understand the current health and status of the user's property, including the property's structure and various systems (e.g., electrical, plumbing, HVAC). The LLM 103 may process this request and may curate a comprehensive list of prioritized tasks, actions, and reminders. These items may be accompanied by educational content that may explain the value and benefit of completing these tasks, helping the user understand why maintaining or upgrading specific elements of the property is important. To make this information actionable, the LLM 103 may generate a one-click application that may enable users to easily access and execute the suggested actions on-demand, making property management more efficient and convenient.

The LLM 103 may interact with the RAG 105 to enhance the specificity and accuracy of the LLM's response. The RAG 105 may retrieve and integrate data from multiple specialized and general sources. In one instance, the RAG 105 may access the general knowledge base built into the LLM model training 111, which may include insights corresponding to common home issues, typical property insurance claims, recommended home improvement projects, cost estimates, and/or repair instructions. The RAG 105 may then supplement this knowledge by querying a plurality of SLMs focused upon specific areas of home and property management. In this instance, the SLMs may include one or more of: (i) SLM 217 upon connected home sensors, (ii) SLM 219 upon connected devices, (iii) SLM 221 upon connected appliances and equipment, (iv) SLM 223 upon smart cameras, (v) SLM 225 upon IoT devices, and/or (vi) SLM 227 upon automated services.

In addition, the RAG 105 may integrate over-the-air data from a wide range of sources. These sources may include one or more of: (i) software-defined vehicle 119 (for vehicle-related maintenance or repair information), (ii) connected smart home ecosystem 121 (e.g., smart thermostats, lighting, energy usage, etc.), (iii) smart devices and sensors 123 (e.g., connected sensors across the home), (iv) interconnected database 125 (e. g, real estate listing, home value data), and/or (v) live web connection 127, which may pull in real-time data from expert sources. These real-time sources may include home repair guidelines, area-specific real estate listings, HOA regulations, and/or local service providers with cost analysis for parts and labor. This rich pool of data may allow for highly specific and up-to-date solutions tailored to the user's request.

Once the RAG 105 has collected the necessary data, it may communicate with a suite of output generation tools designed to provide dynamic and varied responses. These may include (i) code generation tools 131 for generating necessary codes to build the one-click application, (ii) video and 3D environment generation tools 133 for visualizing home projects, (iii) image generation tools 135 to create designs or schematic diagrams, (iv) audio generation tools 137 for creating instructions or guides, (v) text generation tools 139 for generating comprehensive reports, and/or (vi) future media, website, and app generation tools 141 for generating user-friendly interfaces. Additionally, the RAG 105 may communicate with self-creation of an SLM as an output 143 to generate a custom SLM to address specific needs, such as home energy consumption or smart appliance optimization.

After gathering all the relevant data, the RAG 105 may transmit the information back to the LLM 103, which may process the data further through the LLM data deconfliction model 145. This model may identify any conflicting, redundant, or uncertain information that may impact the accuracy of the response. If discrepancies arise between different data sources, the LLM data deconfliction model 145 may prompt the LLM 103 or the user to resolve these conflicts. Once the issue is resolved, the solution becomes a learned rule within the computing system 100, thus ensuring that similar conflicts are handled automatically in the future.

The final result may include an output 229 that may provide the users with a complete overview of the property's health and maintenance needs. This may include:
(i) One-click application that integrates the property's smart systems, sensors, and devices for real-time mentoring and action;
(ii) A visual dashboard displaying the current health status of key property elements, such as roofing, HVAC, plumbing, and electrical systems;
(iii) Education content explaining the importance of regular maintenance and long-term benefits of specific actions;
(iv) Calendared prompts and instructions upon performing actions scheduled at intervals;
(v) Recommendations upon services or parts to order and an interface to schedule or request estimates upon potential costs; and/or
(vi) On-Demand reports detailing completed or recommended maintenance tasks.

This comprehensive solution may empower users to take proactive steps in managing the user's property, using accurate and up-to-date information sourced from a broad spectrum of data sources.

### Exemplary System Architecture for Agent-Based AI-Driven Data Retrieval and Content Generation

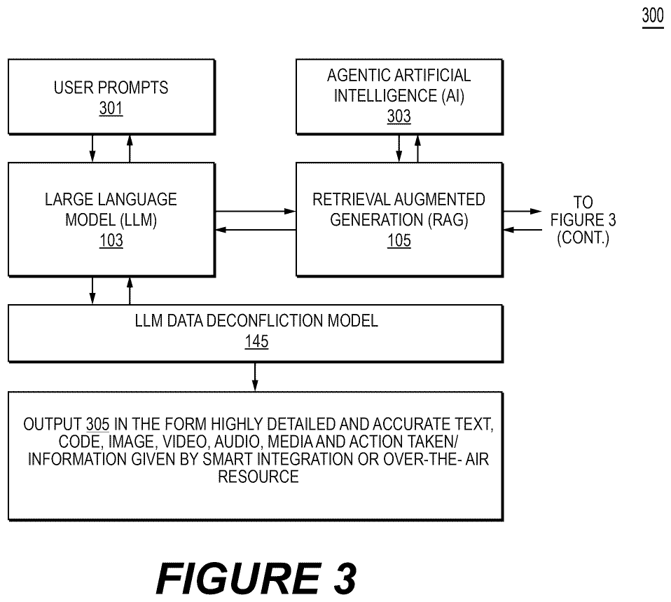

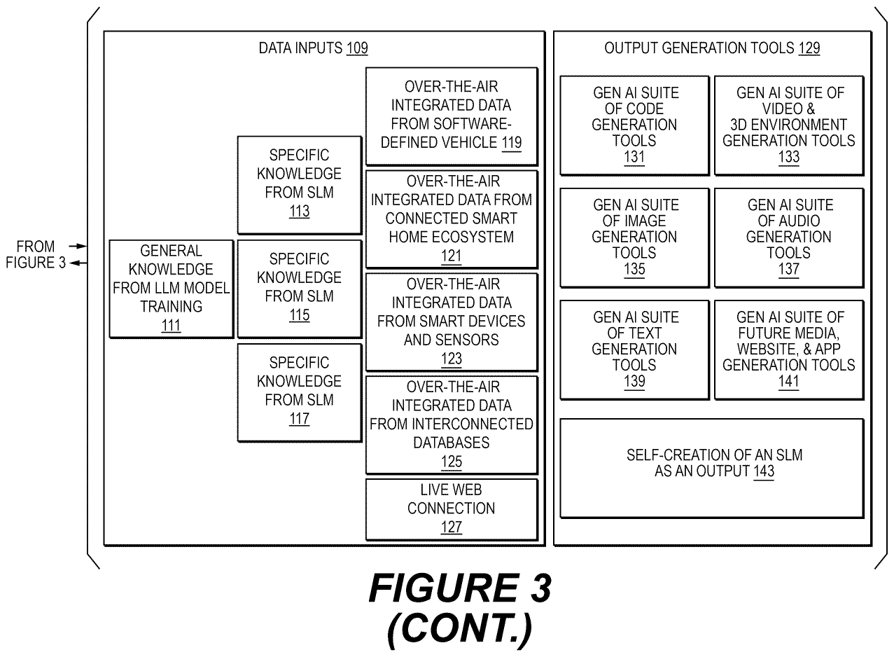

FIG. 3 is a diagram that illustrates an agentic AI that automatically selects data sources, integrations, and output generation tools for content generation, according to certain aspects of the disclosure. FIG. 3 retains the core structure and functional components described in FIG. 1, ensuring consistency in data flow and processing. However, unlike FIG. 1, which relies upon user inputs (e.g., user uploaded files 107), FIG. 3 introduces an agent-based AI (e.g., agentic AI 303) that may automate the selection of data sources, integrations, and/or generative outputs. Since the components in FIG. 3 have been explained in detail in FIG. 1, they will not be reiterated here. The description of FIG. 3 focuses upon the new introduced functionalities (e.g., agentic AI 303).

The computing system 300 may represent an agent-based AI method that may automate the data retrieval, processing, and output generation process, minimizing the need for direct user selection or manual input. The process may begin with user prompts 301 interacting with the LLM 103. The LLM 103 may interact with the RAG 105, which may dynamically retrieve relevant data to supplement the foundational knowledge of the LLM 103. An agentic AI 303 may enhance this process by autonomously determining optional data sources, integrations, and generative outputs based upon the user's query, ensuring that the most relevant information in utilized. The agentic AI may act as an intelligent intermediary between the LLM 103 and the RAG 105, orchestrating seamless interactions across multiple SLMs, live web data, over-the-air integrations, and output generation tools.

In one instance, the agentic AI 303 may include an autonomous decision-making model that may optimize data retrieval, processing, and output generation without relying upon direct user intervention. Unlike traditional models that may rely upon predefined inputs or manual selection of data sources, the agentic AI 303 may dynamically analyze the linguistic structure, intent, and specificity of the user prompts 301 using the NLP techniques. The agentic AI 303 may determine the most relevant knowledge sources and generative outputs needed to provide accurate and contextually rich responses. In one example, the selection process may involve a multi-layered ranking system where the agentic AI 303 may weigh factors such as data accuracy, freshness, reliability, and/or relevance to the query. By autonomously selecting and prioritizing relevant data sources, the agentic AI may enhance both the specificity and breadth of generated responses while mitigating the risk of incomplete or biased outputs.

The agentic AI 303 may also govern the generation and refinement of outputs by dynamically selecting the most suitable tools based upon the user's query. Whether a request may involve generating code, synthesizing multimedia, producing structured data visualizations, or autonomously creating new SLMs tailored to a specialized need, the agentic AI 303 may ensure that the correct generative tools are utilized. Through continuous optimization and learning, the agentic AI 303 may ensure that the most accurate, contextually rich, and diverse knowledge sources are utilized, maximizing precision and depth in the generated response.

Subsequently, the RAG 105, based upon instructions from the agentic AI 303, may interact with various structured and unstructured data sources, including (i) general knowledge embedded in the LLM model training 111, (ii) specialized SLMs (e.g., SLM 113, SLM 115, and SLM 117) that may provide domain-specific expertise, and/or (iii) over-the-air integrated data from sources, such as software-defined vehicles 119, connected smart home ecosystems 121, smart devices and sensors 123, interconnected databases 125, and live web connection 127. This diverse data stream may be then processed and utilized by the RAG 105 to ensure accuracy and contextual relevance.

Additionally, the RAG 105, based upon instructions from the agentic AI 303, may interface with multiple output generation tools 129, such as code generation tools 131, video and 3D environment generation tools 133, image generation tools 135, audio generation tools 137, text generation tools 139, future media, website, and app generation tools 141, and self-creation of a SLM as an output 143 tailored to specific queries.

Once the RAG 105 consolidates the necessary data, it may communicate back with the LLM 103, which then interacts with the LLM data deconfliction model 145 to resolve redundancies and conflicts among multiple sources, ensuring that the final output is both accurate and cohesive. The computing system 300 may generate highly detailed and contextually precise responses in various formats, including text, code, images, video, audio, and other media outputs.

This agent-based AI approach may offer an automated selection, retrieval, and integration of relevant data and output generation. This approach leverages an AI agent to intelligently determine the most appropriate data sources, integrations, and generative outputs based upon the user's prompts. This may remove the burden of manual selections, making the process more efficient, reducing human error, and ensuring access to the most relevant and comprehensive data.

### Exemplary System Architecture for Agent-Based AI-Driven Enterprise Strategy Generation

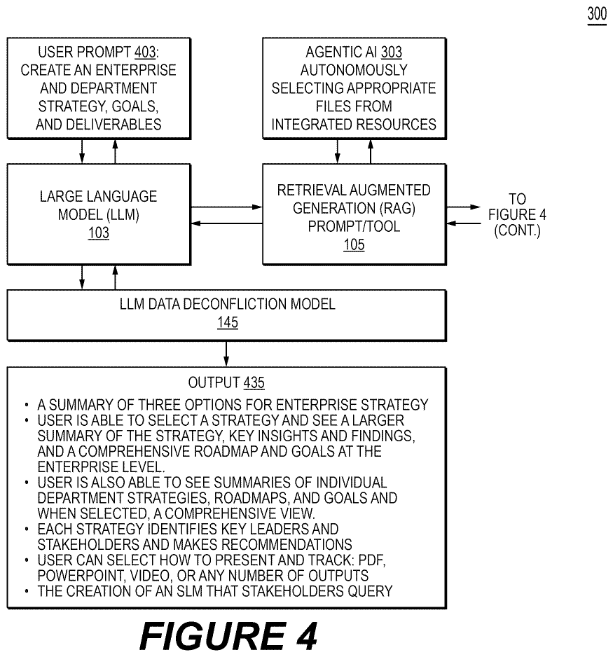

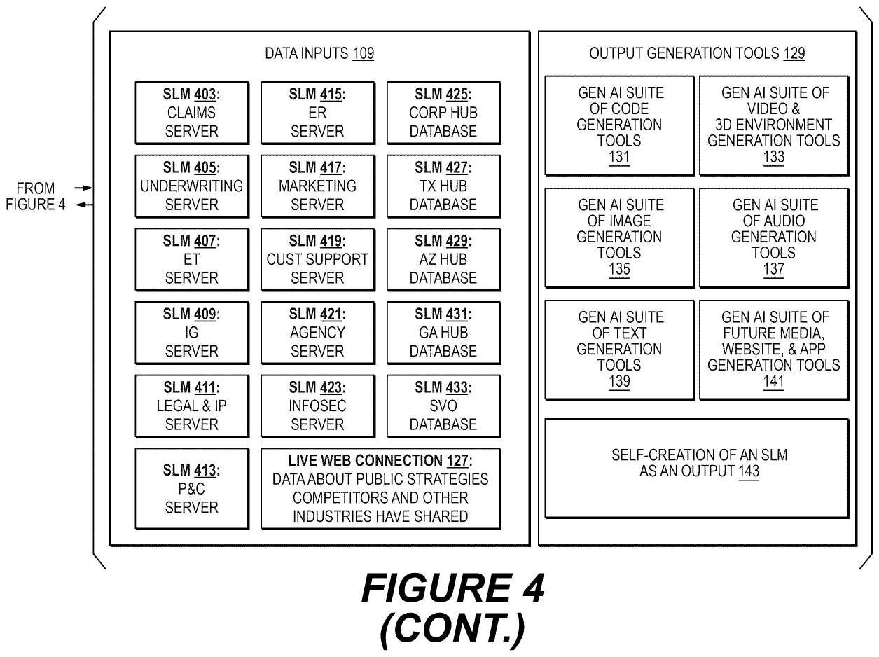

FIG. 4 is a diagram that illustrates an automated, agent-based AI that generates enterprise and departmental strategies, goals, and deliverables, according to certain aspects of the disclosure. FIG. 4 retains the core structure and functional components described in FIGS. 1 and 3. The elements and their interactions in FIG. 4 also follow the same fundamental design as FIGS. 1 and 3. Since the components in FIG. 4 have been explained in detail in FIGS. 1 and 3, the description of FIG. 4 focuses upon the additional functionalities introduced.

The may process begin when users submit user prompt 401 to generate an enterprise and departmental strategy, goals, and deliverables. This request may be transmitted to the LLM 103, which may process the input by analyzing the user's request. The LLM 103 may engage in a bidirectional exchange with the RAG 105 to retrieve relevant data sources beyond its pre-trained knowledge. Simultaneously, the agentic AI 303 may autonomously select relevant fields from integrated resources, eliminating the need for manual user inputs, and feeding them into the RAG 105. The agentic AI 303 may autonomously determine the optimal data inputs to support the requested strategy by evaluating:
(i) the context of the user prompt 401 to understand the industry, scope, and specificity required;
(ii) past interactions and stored preferences to check if previous strategy-related queries exist, and the agentic AI 303 may refine selection based upon historical data;
(iii) querying the RAG 105 for structured knowledge to select appropriate SLMs for targeted expertise;
(iv) activating necessary LLMs by choosing from internal enterprise knowledge bases or external premium AI models; and/or
(v) determining real-time web data necessity to supplement missing or time-sensitive information.

The RAG 105 may pull data from multiple structured sources, including SLMs dedicated to specific business functions (e.g., claims processing, underwriting, marketing, etc.), LLMs connected to various corporate and regional databases, and a live-web connection that may gather real-time public strategy insights from competitors and industry trends. The agentic AI 303 may autonomously select the most relevant fields from multiple SLMs, such as:
(i) SLM 403: a claims server for insurance or legal matters;
(ii) SLM 405: an underwriting server for risk assessment in financial institutions;
(iii) SLM 407: an ET server for emerging technologies and future trends;
(iv) SLM 409: an IG server for governance and regulatory compliance;
(v) SLM 411: a legal and IP server for intellectual property and corporate law;
(vi) SLM 413: a P&C server for property and casualty data analytics;
(vii) SLM 415: an ER server for employee relations and data relating to human resources;
(viii) SLM 417: a marketing server for banding and outreach;
(ix) SLM 419: a customer support server for banding and outreach strategy;
(xi) SLM 421: an agency server for partnership and external collaborations; and/or
(xi) SLM 423: an InfoSec server for cybersecurity data.

The agentic AI 303 may also autonomously select the most relevant fields from multiple LLMs, such as:
(i) LLM 425: a corporate hub database for aggregating company-wide policies and past strategies;
(ii) LLM 427: a TX hub database for Texas regional data and market trends;
(iii) LLM 429: an AZ hub database for Arizona-specific strategy inputs;
(iv) LLM 431: a GA hub database for Georgia market insights; and/or
(v) LLM 433: an SVO database for strategic vision and objective repository.

The agentic AI 303 may also autonomously select the most relevant fields from the live web connection 127 to gather (i) publicly shared business strategies, (ii) industry benchmarks and best practices, and/or (iii) market trends analysis in real-time.

Once the agentic AI 303 finalizes the selection of structured and unstructured data, the RAG model may dynamically integrate these inputs with various output generation tools 129 for enabling diverse strategy presentation formats including code, images video, 3D environments, audio, texts, applications, and self-generated SLMS tailored to specific enterprise needs.

After initial data aggregation, the RAG 105 may re-engage with the LLM 103 to refine and contextualize insights. The LLM 103 may forward the retrieved and generated data to the LLM data deconfliction model 145 for identifying conflicting, redundant, or outdated information. Once the conflict is resolved, the computing system 300 may generate output 435 that may include three refined enterprise strategy options presented to the user in selectable formats. The user may select a strategy and see a larger summary of the strategy, key insights and findings, and a comprehensive roadmap and goals at the enterprise level. The user may also select a comprehensive view to view summaries of individual department strategies, roadmaps, and goals. Each strategy may identify key leaders and stakeholders and make recommendations. The user may select how to present and track the data (e.g., PDF, PowerPoint, Video, or any number of outputs).

### Exemplary Agent-Based AI-Driven Data Processing Flowchart

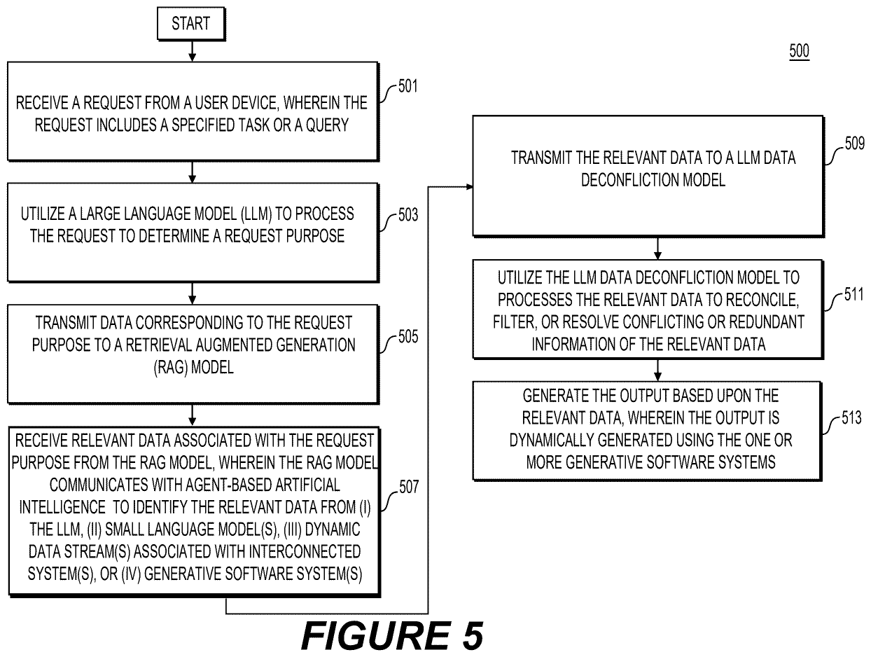

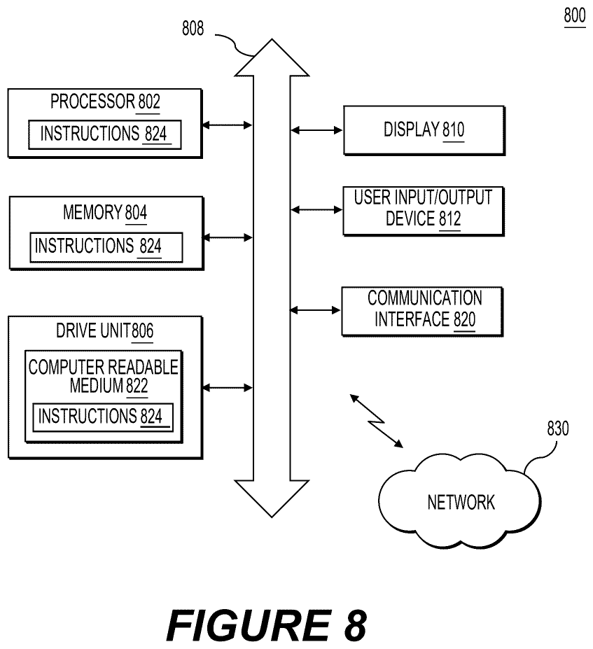

FIG. 5 is an exemplary flowchart of a computer-implemented or computer-based process for dynamically generating output through AI-driven data retrieval, processing, and contextual analysis of interconnected data sources, according to certain aspects of the disclosure. In one instance, the LLM 103, the RAG 105, the LLM data deconfliction model 145, and the agentic AI 303 of FIG. 3 may perform one or more portions of the process 500 and are implemented using, for instance, a chip set including a processor (e.g., processor 802) and a memory (e.g., memory 804) as shown in FIG. 8. As such, the LLM 103, the RAG 105, the LLM data deconfliction model 145, and the agentic AI 303 may be configured to facilitate accomplishing various parts of the process 500, as well as accomplishing embodiments of other processes described herein in conjunction with other components of the computing system 300 of FIG. 3. Although the process 500 is illustrated and described as a sequence of actions, operations, and/or functionality, it is contemplated that various embodiments of the process 500 may be performed in any order or combination and need not include all of the illustrated actions, operations, and/or functionality.

In block 501, one or more processors (e.g., processors 802) may receive a request (e.g., user prompts 301) from a user device (e.g., smartphone or computer). The request may include a specified task (e.g., instruction to generate specific content) or a query (e.g., request for additional information). The user may input data into the user device, where the system may generate a request based on the input data.

In block 503, one or more processors may utilize the LLM 103 to process the request to determine a request purpose. In one instance, determining the request purpose may include the LLM 103 processing the request to extract (i) one or more keywords and/or (ii) one or more phrases indicative of a user intent. The LLM 103 may apply NLP techniques to classify (i) one or more keywords and/or (ii) one or more phrases into one or more categories. The one or more categories may include one or more general knowledge topics (e.g., access the LLM model training 111), one or more specialized domains (e.g., access the SLMs), and/or one or more task-specific intents.

In block 505, one or more processors may transmit the data corresponding to the request purpose to the RAG 105. In one instance, the data corresponding to the request purpose may include one or more of (i) metadata associated with the request (e.g., timestamps, request ID, language settings, or the source of the application), (ii) historical user interaction data relevant to the request (e.g., prior queries, feedbacks, or behavioral patterns that may facilitate refining the current request), (iii) data identifying domain or category of the request (e.g., a query like “what are the tax implications of selling stock?” may be categorized into a predefined category to determine the appropriate knowledge sources), and/or (iv) contextual parameters associated with the request (e.g., dynamic inputs that may adjust the response based upon situational factors, such as user location or current trends).

In block 507, one or more processors may receive the relevant data associated with the request purpose from the RAG 105. The RAG 105 may communicate with one or more agent-based AI systems (e.g., agentic AI 303) to identify the relevant data from (i) the LLM model training 111, (ii) one or more SLMs (e.g., SLMs 113, 115, and 117), (iii) one or more dynamic data streams associated with one or more interconnected systems (e.g., over-the-air integrated data or live web connection system) and/or (iv) one or more generative software systems (e.g., output generation tools 129).

In one instance, the RAG 105 may communicate with the LLM model training 111 to retrieve general-purpose knowledge by analyzing historical training data to identify the relevant data. The one or more agent-based AI systems may facilitate the communication by automating the retrieval process based upon a request context.

In one instance, the RAG 105 may communicate with one or more SLMs trained upon one or more datasets corresponding to one or more specific domains to retrieve domain-specific knowledge corresponding to the request. The one or more agent-based AI systems may facilitate the communication by automating a selection of a SLM based upon a request context.

In one instance, one or more dynamic data streams associated with the one or more interconnected systems may include (i) telemetry data from one or more software-defined vehicles 119, the telemetry data may include vehicle telematics data, such as ABC data (acceleration, braking, cornering data), and vehicle location, route, GPS, and speed data, and other vehicle data; (ii) sensor data from one or more smart houses (e.g., connected smart home ecosystem 121), which may include home telematics data, which may include home sensor data, smart appliance data, energy and water usage (within or by a home) data, and other home telematics data; (iii) personalized user data from one or more smart devices and sensors 123; and/or (iv) multi-dimensional data stream from one or more interconnected databases 125.

Additionally, the telemetry data may also include an operational status, one or more diagnostics, or one or more environmental conditions. The sensor data may include temperature data, one or more security camera feeds, or energy consumption. The personalized user data may include one or more health metrics, location information, or one or more user activity logs. The multi-dimensional data stream may include structured data, one or more real-time data feeds, historical data, business intelligence data, or user generated data.

The one or more agent-based AI systems may facilitate the communication between the RAG 105 and the one or more interconnected systems by automating a selection of relevant dynamic data based upon a request context.

In one instance, one or more interconnected databases may include one or more of (i) a public cloud storage, (ii) a private cloud storage, (iii) a subscription-based proprietary database, and/or (iv) an open source knowledge graph and ontologies. The RAG 105 may communicate with a live web connection 127 to perform real-time web scraping, indexing, and/or querying of the one or more interconnected databases to supplement the relevant data.

In one instance, the one or more generative software systems may include (i) a code generation tool 131 to generate one or more executable programming scripts, (ii) a text generation tool 139 to generate one or more human-readable textual responses, (iii) an image generation tool 135 to create a visual representation based upon the relevant data, (iv) a video generation tool (e.g., video and 3D environment generation tool 133) to produce one or more animated or real-world video outputs, (v) an audio generation tool 137 to generate one or more aural responses, and/or (vi) a media generation tool (e.g., future media, website, and app generation tool 141) to develop one or more websites, one or more applications, or one or more interactive environments. The one or more agent-based AI systems may select and configure at least one generative software system based upon the relevant data.

In block 509, one or more processors transmit the relevant data to a LLM data deconfliction model 145. The LLM data deconfliction model 145 may analyze the incoming information from various sources.

In block 511, one or more processors may utilize the LLM data deconfliction model 145 to process the relevant data to reconcile, filter, or resolve conflicting or redundant information of the relevant data. In one instance, the LLM data deconfliction model 145 may reconcile the conflicting information by assigning one or more confidence scores to one or more data elements associated with the relevant data based upon (i) a data source, (ii) recency and relevance of the data to the purpose of the request, and/or (iii) consistency of the data with corroborating information retrieved from the one or more data sources. Then, the LLM data deconfliction model 145 may rank the one or more data elements based upon the one or more confidence scores. The LLM data deconfliction model 145 may filter the one or more data elements with confidence scores to remove at least one of the one or more data elements with a confidence score below a predetermined threshold.

In another instance, the LLM data deconfliction model 145 may resolve the redundant information by identifying one or more semantically equivalent data points through a similarity scoring process. An NLP technique may analyze the contextual meaning of each data point and may assign a similarity score based upon the semantic proximity of one or more data points. The one or more data points with a high similarity score may be grouped together and considered equivalent for the purpose of the request. The LLM data deconfliction model 145 may filter duplicate or overlapping data based upon the similarity score.

In block 513, one or more processors may generate the output (e.g., output 305) based upon the relevant data. The output may be dynamically generated using the one or more generative software systems (e.g., the output generation tools 129). The output may be presented in a user interface of the user device.

### Exemplary Data Processing and Content Generation Based Upon User-Defined Configurations Flowchart

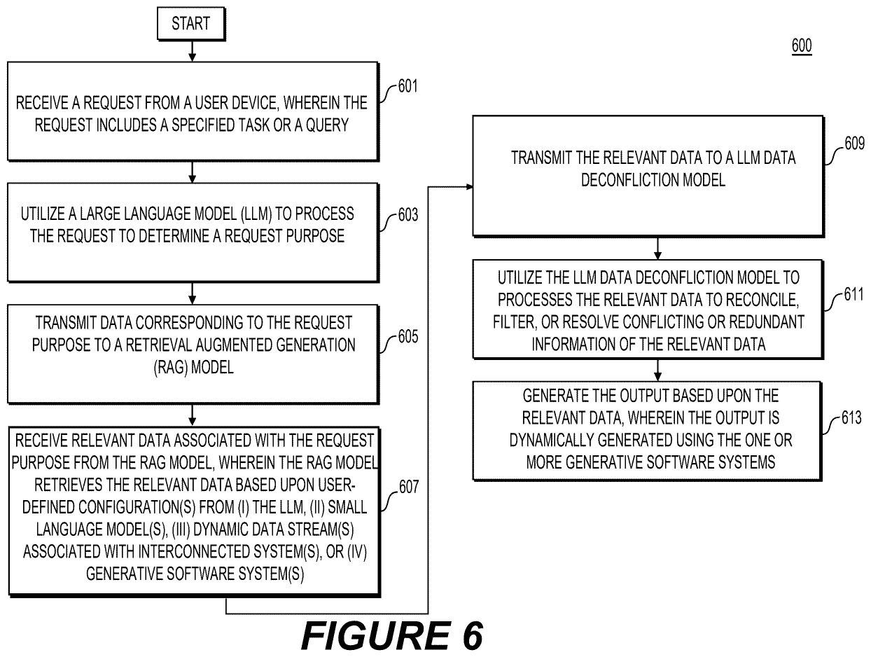

FIG. 6 is an exemplary flowchart of a computer-implemented or computer-based process for dynamically generating output in response to user input through interconnected data retrieval and processing, according to certain aspects of the disclosure. In one instance, the LLM 103, the RAG 105, and the LLM data deconfliction model 145 of FIG. 1 based upon user-defined configurations (e.g., user uploaded files 107) may perform one or more portions of the process 600 and are implemented using, for instance, a chip set including a processor (e.g., processor 802) and a memory (e.g., memory 804) as shown in FIG. 8. As such, the LLM 103, the RAG 105, and the LLM data deconfliction model 145 may be configured to facilitate accomplishing various parts of the process 600, as well as accomplishing embodiments of other processes described herein in conjunction with other components of the computing system 100 of FIG. 1. Although the process 600 is illustrated and described as a sequence of actions, operations, and/or functionality, it is contemplated that various embodiments of the process 600 may be performed in any order or combination and need not include all of the illustrated actions, operations, and/or functionality.

In block 601, one or more processors (e.g., processors 802) may receive a request (e.g., user prompts 101) from a user device (e.g., smartphone or computer). The request may include a specified task (e.g., instruction to generate specific content) or a query (e.g., request for additional information). The user may input data into the user device, where the system may generate a request based on the input data.

In block 603, one or more processors may utilize the LLM 103 to process the request to determine a request purpose. In one instance, determining the request purpose may include the LLM 103 processing the request to extract (i) one or more keywords or (ii) one or more phrases indicative of a user intent. The LLM 103 may apply NLP techniques to classify (i) one or more keywords, and/or (ii) one or more phrases into one or more categories. The one or more categories may include one or more general knowledge topics (e.g., access the LLM model training 111), one or more specialized domains (e.g., access the SLMs), and/or one or more task-specific intents.

In block 605, one or more processors may transmit the data corresponding to the request purpose to the RAG 105. In one instance, the data corresponding to the request purpose may include one or more of (i) metadata associated with the request, (ii) historical user interaction data relevant to the request, (iii) data identifying domain or category of the request, and/or (iv) contextual parameters associated with the request.

In block 607, one or more processors may receive the relevant data associated with the request purpose from the RAG 105. The RAG 105 may retrieve the relevant data based upon user-defined configurations from (i) the LLM model training 111, (ii) one or more SLMs (e.g., SLMs 113, 115, and 117), (iii) one or more dynamic data streams associated with one or more interconnected systems (e.g., over-the-air integrated data or live web connection system) and/or (iv) one or more generative software systems (e.g., output generation tools 129).

In one instance, the RAG 105 may communicate with the LLM model training 111 to retrieve general-purpose knowledge by analyzing historical training data to identify the relevant data. The retrieval process may be based upon the user-defined configuration(s) that specify one or more of (i) data type priority, (ii) data source priority, (iii) retrieval depth, and/or (iv) one or more criteria for contextual filtering.

In one instance, the RAG 105 may communicate with one or more SLMs trained upon one or more datasets corresponding to one or more specific domains to retrieve domain-specific knowledge corresponding to the request. The retrieval process may be based upon one or more user-defined configurations that specify one or more of (i) selection of SLM based upon training focus, (ii) inclusion or exclusion of specific dataset categories, and/or (iii) one or more criteria for evaluating relevance and context of retrieved domain-specific knowledge.

In one instance, one or more dynamic data streams associated with the one or more interconnected systems may include (i) telemetry data from one or more software-defined vehicles 119, which may include (a) vehicle telematics data, such as ABC (acceleration, braking, cornering data); (b) vehicle location, speed, direction, heading, route, and other data; (c) smart vehicle data, which may include smart vehicle images and/or videos; and/or (d) autonomous or semi-autonomous vehicle data, which may include data related to control decisions and/or other operational data of autonomous vehicle systems and features; (ii) sensor data from one or more smart houses (e.g., connected smart home ecosystem 121), which may include home telematics data, which may include energy usage data, water usage data, or the like; (iii) personalized user data from one or more smart devices and sensors 123 (which may be use with customer affirmative permission or consent), and/or (iv) multi-dimensional data stream from one or more interconnected databases 125.

Additionally, the telemetry data may also include an operational status, one or more diagnostics, or one or more environmental conditions. The sensor data may include temperature data, one or more security camera feeds, or energy consumption. The personalized user data may include one or more health metrics, location information, or one or more user activity logs. The multi-dimensional data stream may include structured data, one or more real-time data feeds, historical data, business intelligence data, or user generated data.

The selection and configuration of one or more dynamic data streams may be based upon one or more user-defined configurations that specify one or more of (i) selection of specific data streams from the one or more interconnected systems, (ii) customization of integration of the one or more interconnected systems into the RAG model, and/or (iii) parameters for filtering or normalization of selected data streams.

In one instance, one or more interconnected databases may include one or more of (i) a public cloud storage, (ii) a private cloud storage, (iii) a subscription-based proprietary database, and/or (iv) an open source knowledge graph and ontologies. The RAG 105 may communicate with a live web connection 127 to perform real-time web scraping, indexing, and/or querying of the one or more interconnected databases to supplement the relevant data.

In one instance, the one or more generative software systems may include (i) a code generation tool 131 to generate one or more executable programming scripts, (ii) a text generation tool 139 to generate one or more human-readable textual responses, (iii) an image generation tool 135 to create a visual representation based upon the relevant data, (iv) a video generation tool (e.g., video and 3D environment generation tool 133) to produce one or more animated or real-world video outputs, (v) an audio generation tool 137 to generate one or more aural responses, and/or (vi) a media generation tool (e.g., future media, website, and app generation tool 141) to develop one or more websites, one or more applications, or one or more interactive environments. The generative software system may be selected and configured based upon one or more user-defined configurations that specify a generative software system to use for generating the output.

In block 609, one or more processors transmit the relevant data to a LLM data deconfliction model 145. The LLM data deconfliction model 145 may analyze the incoming information from various sources.

In block 611, one or more processors may utilize the LLM data deconfliction model 145 to process the relevant data to reconcile, filter, or resolve conflicting or redundant information of the relevant data. In one instance, the LLM data deconfliction model 145 may reconcile the conflicting information by assigning one or more confidence scores to one or more data elements associated with the relevant data based upon (i) a data source, (ii) recency and relevance of the data to the purpose of the request, and/or (iii) consistency of the data with corroborating information retrieved from the one or more data sources. Then, the LLM data deconfliction model 145 may rank the one or more data elements based upon the one or more confidence scores. The LLM data deconfliction model 145 may filter the one or more data elements with confidence scores to remove at least one of the one or more data elements with a confidence score below a predetermined threshold.

In another instance, the LLM data deconfliction model 145 may resolve the redundant information by identifying one or more semantically equivalent data points through a similarity scoring process. An NLP technique may analyze the contextual meaning of each data point and may assign a similarity score based upon the semantic proximity of one or more data points. The one or more data points with a high similarity score may be grouped together and considered equivalent for the purpose of the request. The LLM data deconfliction model 145 may filter duplicate or overlapping data based upon the similarity score.

In block 613, one or more processors may generate the output (e.g., output 147) based upon the relevant data. The output may be dynamically generated using the one or more generative software systems (e.g., the output generation tools 129). The output may be presented in a user interface of the user device.

### Exemplary Machine-Learning Techniques

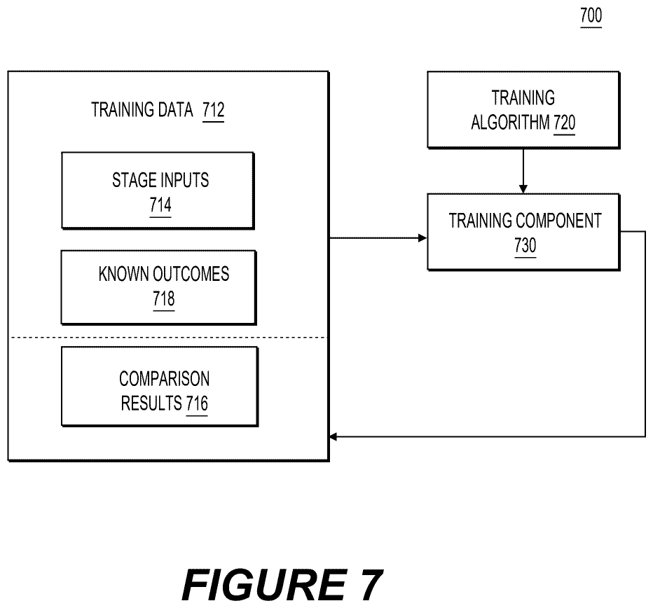

One or more implementations disclosed herein may include and/or may be implemented using a machine-learning model. For example, the LLM 103, the RAG 105, the LLM model training 111, SLMs (e.g., SLMs 113, 115, and 117), LLM data deconfliction model 145, and agentic AI 303 may be implemented using a machine-learning model and/or may be used to train the machine-learning model. A given machine-learning model may be trained using the data flow 700 of FIG. 7. Training data 712 may include one or more of stage inputs 714 and known outcomes 718 related to the machine-learning model to be trained. The stage inputs 714 may be from any applicable source including text, visual representations, data, values, comparisons, stage outputs, e.g., one or more outputs from one or more actions or operations from FIGS. 5 and 6. The known outcomes 718 may be included for the machine-learning models generated based upon supervised or semi-supervised training. An unsupervised machine-learning model may not be trained using known outcomes 718. Known outcomes 718 may include known or desired outputs for future inputs similar to, or in the same category as, stage inputs 714 that do not have corresponding known outputs.

The training data 712 and a training algorithm 720, e.g., one or more of the modules implemented using the machine-learning model and/or may be used to train the machine-learning model, may be provided to a training component 730 that may apply the training data 712 to the training algorithm 720 to generate the machine-learning model. According to an implementation, the training component 730 may be provided comparison results 716 that compare a previous output of the corresponding machine-learning model to apply the previous result to re-train the machine-learning model. The comparison results 716 may be used by training component 730 to update the corresponding machine-learning model. The training algorithm 720 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any process or operation discussed in this disclosure is understood to be computer-implementable, such as the processes illustrated in FIGS. 5 and 6 may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

### Exemplary Computing Environment

In general, any process or operation discussed in this disclosure is understood to be computer-implementable, such as the processes illustrated in FIGS. 5 and 6 and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 8 illustrates an implementation of a computer system that may execute techniques presented herein. The computer system 800 may include a set of instructions that can be executed to cause the computer system 800 to perform any one or more of the methods or computer based functions disclosed herein. The computer system 800 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 800 may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a Personal Digital Assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 800 may be implemented using electronic devices that provide voice, video, or data communication. Further, while the computer system 800 is illustrated as a single system, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a Central Processing Unit (CPU), a Graphics Processing Unit (GPU), or both. The processor 802 may be a component in a variety of systems. For example, the processor 802 may be part of a standard personal computer or a workstation. The processor 802 may be one or more processors, digital signal processors, application specific integrated circuits, field programmable gate arrays, servers, networks, digital circuits, analog circuits, combinations thereof, or other now known or later developed devices for analyzing and processing data. The processor 802 may implement a software program, such as code generated manually (i.e., programmed).

The computer system 800 may include a memory 804 that can communicate via bus 808. The memory 804 may be a main memory, a static memory, or a dynamic memory. The memory 804 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 804 may include a cache or random-access memory for the processor 802. In alternative implementations, the memory 804 is separate from the processor 802, such as a cache memory of a processor, the system memory, or other memory.

The memory 804 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 804 is operable to store instructions executable by the processor 802. The functions, acts or tasks illustrated in the figures or described herein may be performed by the processor 802 executing the instructions stored in the memory 804. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 800 may further include a display 810, such as a liquid crystal display (LCD), an organic light emitting diode (OLED), a flat panel display, a solid-state display, a cathode ray tube (CRT), a projector, a printer or other now known or later developed display device for outputting determined information. The display 810 may act as an interface for the user to see the functioning of the processor 802, or specifically as an interface with the software stored in the memory 804 or in the drive unit 806.

Additionally or alternatively, the computer system 800 may include an input/output device 812 configured to allow a user to interact with any of the components of the computer system 800. The input/output device 812 may be a number pad, a keyboard, or a cursor control device, such as a mouse, or a joystick, touch screen display, remote control, or any other device operative to interact with the computer system 800.

The computer system 800 may also or alternatively include drive unit 806 implemented as a disk or optical drive. The drive unit 806 may include a computer-readable medium 822 in which one or more sets of instructions 824, e.g., software, can be embedded. Further, instructions 824 may embody one or more of the methods or logic as described herein. The instructions 824 may reside completely or partially within the memory 804 and/or within the processor 802 during execution by the computer system 800. The memory 804 and the processor 802 also may include computer-readable media as discussed above.

In some systems, computer-readable medium 822 may include the set of instructions 824 or receive and execute the set of instructions 824 responsive to a propagated signal so that a device connected to network 830 can communicate voice, video, audio, images, or any other data over the network 830. Further, the set of instructions 824 may be transmitted or received over the network 830 via communication port or interface 820, and/or using bus 808. The communication port or interface 820 may be a part of the processor 802 or may be a separate component. The communication port or interface 820 may be created in software or may be a physical connection in hardware.

The communication port or interface 820 may be configured to connect with a network 830, external media, the display 810, or any other components in computer system 800, or combinations thereof. The connection with the network 830 may be a physical connection, such as a wired Ethernet connection or may be established wirelessly as discussed below. Likewise, the additional connections with other components of the computer system 800 may be physical connections or may be established wirelessly. The network 830 may alternatively be directly connected to the bus 808.

While the computer-readable medium 822 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 822 may be non-transitory, and may be tangible.

The computer-readable medium 822 may include a solid-state memory such as a memory card or other package that houses one or more non-volatile read-only memories. The computer-readable medium 822 can be a random-access memory or other volatile re-writable memory. Additionally or alternatively, the computer-readable medium 822 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 800 may be connected to network 830. The network 830 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 830 may include wide area networks (WAN), such as the Internet, local area networks (LAN), campus area networks, metropolitan area networks, a direct connection such as through a Universal Serial Bus (USB) port, or any other networks that may allow for data communication.

The network 830 may be configured to couple one computing device to another computing device to enable communication of data between the devices. The network 830 may generally be enabled to employ any form of machine-readable media for communicating information from one device to another. The network 830 may include communication methods by which information may travel between computing devices.

The network 830 may be divided into sub-networks. The sub-networks may allow access to all of the other components connected thereto or the sub-networks may restrict access between the components. The network 830 may be regarded as a public or private network connection and may include, for example, a virtual private network or an encryption or other security mechanism employed over the public Internet, or the like.

### Exemplary Embodiment

A computer-implemented method for dynamically generating output through artificial intelligence (AI) driven data retrieval, processing, and contextual analysis of interconnected data sources may be provided. The computer-implemented method may be performed by one or more local or remote processors of a computing system in communication with one or more local or remote data sources. The computer-implemented method may include: (1) receiving, by the one or more processors, a request from a user device, wherein the request includes a specified task or a query; (2) utilizing, by the one or more processors, a large language model (LLM) to process the request to determine a request purpose; (3) transmitting, by the one or more processors, data corresponding to the request purpose to a retrieval augmented generation (RAG) model; (4) receiving, by the one or more processors, relevant data associated with the request purpose from the RAG model, wherein the RAG model communicates with one or more agent-based AI systems to identify the relevant data from (i) the LLM, (ii) one or more small language models (SLMs), (iii) one or more dynamic data streams associated with one or more interconnected systems, and/or (iv) one or more generative software systems; (5) transmitting, by the one or more processors, the relevant data to a LLM data deconfliction model; (6) utilizing, by the one or more processors, the LLM data deconfliction model to processes the relevant data to reconcile, filter, or resolve conflicting or redundant information of the relevant data; (7) generating, by the one or more processors, the output based upon the relevant data, wherein the output is dynamically generated using the one or more generative software systems; and/or (8) outputting, by the one or more processors, the output to a user interface of the user device.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for generative AI, ChatGPT, InstructGPT bot, Codex bot, or Google Bard bot.

In certain aspects, determining the request purpose may include (i) processing, by the one or more processors, via the LLM, the request to extract one or more keywords or one or more phrases indicative of a user intent; and/or (ii) applying, by the one or more processors, via the LLM, one or more natural language processing (NLP) techniques to classify the one or more keywords or the one or more phrases into one or more categories.

Additionally or alternatively, the one or more categories may include one or more general knowledge topics, one or more specialized domains, and/or one or more task-specific intents.

In various embodiments, the RAG model may communicate with the LLM to retrieve general-purpose knowledge by analyzing historical training data to identify the relevant data, and wherein the one or more agent-based AI systems may facilitate the communication by automating the retrieval process based upon a request context.

In certain embodiments, the RAG model may communicate with the one or more SLMs trained upon one or more datasets corresponding to one or more specific domains to retrieve domain-specific knowledge corresponding to the request, and wherein the one or more agent-based AI systems may facilitate the communication by automating a selection of a SLM based upon a request context.

In some embodiments, the one or more dynamic data streams associated with the one or more interconnected systems may include (i) telemetry data from one or more software-defined vehicles (which may include (a) vehicle telematics data, such as ABC data or smart vehicle images and videos, and/or (b) autonomous and/or semi-autonomous vehicle data); (ii) sensor data from one or more smart houses (which may include smart home data, home telematics data (such as home energy usage and/or home water usage data), smart construction or building material data, etc. ; (iii) personalized user data from one or more smart devices; and/or (iv) multi-dimensional data stream from one or more interconnected databases. The one or more agent-based AI systems may facilitate the communication between the RAG model and the one or more interconnected systems by automating a selection of relevant dynamic data based upon a request context.

Additionally or alternatively, the telemetry data may include an operational status, one or more diagnostics, and/or one or more environmental conditions. The sensor data may include temperature data, one or more security camera feeds, and/or energy consumption. The personalized user data may include one or more health metrics, location information, and/or one or more user activity logs. The multi-dimensional data stream may include structured data, one or more real-time data feeds, historical data, business intelligence data, and/or user generated data.

In certain aspects, the one or more interconnected databases may include one or more of (i) a public cloud storage, (ii) a private cloud storage, (iii) a subscription-based proprietary database, and/or (iv) an open source knowledge graph and ontologies.

In various embodiments, the RAG model may communicate with a live web connection to perform real-time web scraping, indexing, and/or querying of the one or more interconnected databases to supplement the relevant data.

In certain embodiments, the one or more generative software systems may include (i) a code generation tool to generate one or more executable programming scripts, (ii) a text generation tool to generate one or more human-readable textual responses, (iii) an image generation tool to create a visual representation based upon the relevant data, (iv) a video generation tool to produce one or more animated or real-world video outputs, (v) an audio generation tool to generate one or more aural responses, and/or (vi) a media generation tool to develop one or more websites, one or more applications, or one or more interactive environments. The one or more agent-based AI systems may select and configure at least one generative software system based upon the relevant data.

In some embodiments, the LLM data deconfliction model reconciling the conflicting information may include (i) assigning, by the one or more processors, via the LLM data deconfliction model, one or more confidence scores to one or more data elements associated with the relevant data based upon (a) a data source, (b) recency and relevance of the data to the purpose of the request, and/or (c) consistency of the data with corroborating information retrieved from the one or more data sources; (ii) ranking, by the one or more processors, via the LLM data deconfliction model, the one or more data elements based upon the one or more confidence scores; and/or (iii) filtering, by the one or more processors, via the LLM data deconfliction model, the one or more data elements with confidence scores to remove at least one of the one or more data elements with a confidence score below a predetermined threshold.

In certain aspects, the LLM data deconfliction model resolving the redundant information may include (i) identifying, by the one or more processors, via the LLM data deconfliction model, one or more semantically equivalent data points through a similarity scoring process, wherein a natural language processing (NLP) technique may analyze a contextual meaning of each data point and assigns a similarity score based upon a semantic proximity of one or more data points, and wherein the one or more data points with high similarity score may be grouped together and considered equivalent for the purpose of the request; and/or (ii) filtering, by the one or more processors, via the LLM data deconfliction model, duplicate or overlapping data based upon the similarity score.

In certain aspects, the data corresponding to the request purpose may include one or more of (i) metadata associated with the request, (ii) historical user interaction data relevant to the request, (iii) data identifying domain or category of the request, and/or (iv) contextual parameters associated with the request.

A computer system for dynamically generating output through artificial intelligence (AI) driven data retrieval, processing, and contextual analysis of interconnected data sources may be provided. The computer system may include one or more processors of a computing system, and at least one non-transitory computer readable medium storing instructions which, when executed by the one or more processors, cause the one or more processors to perform operations. The computer system may perform operations including (1) receiving a request from a user device, wherein the request includes a specified task or a query; (2) utilizing a large language model (LLM) to process the request to determine a request purpose; (3) transmitting data corresponding to the request purpose to a retrieval augmented generation (RAG) model; (4) receiving relevant data associated with the request purpose from the RAG model, wherein the RAG model communicates with one or more agent-based AI systems to identify the relevant data from (i) the LLM, (ii) one or more small language models (SLMs), (iii) one or more dynamic data streams associated with one or more interconnected systems, and/or (iv) one or more generative software systems; (5) transmitting the relevant data to a LLM data deconfliction model; (6) utilizing the LLM data deconfliction model to processes the relevant data to reconcile, filter, or resolve conflicting or redundant information of the relevant data; (7) generating the output based upon the relevant data, wherein the output is dynamically generated using the one or more generative software systems; and/or (8) outputting the output to a user interface of the user device.

In certain aspects, determining the request purpose may include (i) processing via the LLM, the request to extract one or more keywords or one or more phrases indicative of a user intent; and/or (ii) applying via the LLM, one or more natural language processing (NLP) techniques to classify the one or more keywords or the one or more phrases into one or more categories. The one or more categories include one or more general knowledge topics, one or more specialized domains, or one or more task-specific intents.

In some embodiments, the RAG model may communicate with the LLM to retrieve general-purpose knowledge by analyzing historical training data to identify the relevant data, and wherein the one or more agent-based AI systems may facilitate the communication by automating the retrieval process based upon a request context.

In certain embodiments, the RAG model may communicate with the one or more SLMs trained upon one or more datasets corresponding to one or more specific domains to retrieve domain-specific knowledge corresponding to the request, and wherein the one or more agent-based AI systems may facilitate the communication by automating a selection of a SLM based upon a request context.

In various embodiments, the one or more dynamic data streams associated with the one or more interconnected systems may include (i) telemetry data from one or more software-defined vehicles (which may include vehicle telematics data and/or autonomous vehicle data, and other types of vehicle-related data as indicated elsewhere herein), (ii) sensor data from one or more smart houses (which may include home telematics data and other types of home-related data as indicated elsewhere herein), (iii) personalized user data from one or more smart devices, and/or (iv) multi-dimensional data stream from one or more interconnected databases. The one or more agent-based AI systems may facilitate the communication between the RAG model and the one or more interconnected systems by automating a selection of relevant dynamic data based upon a request context.

A non-transitory computer readable medium for dynamically generating output through artificial intelligence (AI) driven data retrieval, processing, and contextual analysis of interconnected data sources may be provided. The non-transitory computer readable medium may store instructions which, when executed by one or more processors, cause the one or more processors to perform operations. The one or more processors may perform operations including (1) receiving a request from a user device, wherein the request includes a specified task or a query; (2) utilizing a large language model (LLM) to process the request to determine a request purpose; (3) transmitting data corresponding to the request purpose to a retrieval augmented generation (RAG) model; (4) receiving relevant data associated with the request purpose from the RAG model, wherein the RAG model communicates with one or more agent-based AI systems to identify the relevant data from (i) the LLM, (ii) one or more small language models (SLMs), (iii) one or more dynamic data streams associated with one or more interconnected systems, and/or (iv) one or more generative software systems; (5) transmitting the relevant data to a LLM data deconfliction model; (6) utilizing the LLM data deconfliction model to processes the relevant data to reconcile, filter, or resolve conflicting or redundant information of the relevant data; (7) generating the output based upon the relevant data, wherein the output is dynamically generated using the one or more generative software systems; and/or (8) outputting the output to a user interface of the user device.

In some embodiments, determining the request purpose may include (i) processing via the LLM, the request to extract one or more keywords or one or more phrases indicative of a user intent; and/or (ii) applying via the LLM, one or more natural language processing (NLP) techniques to classify the one or more keywords or the one or more phrases into one or more categories. The one or more categories may include one or more general knowledge topics, one or more specialized domains, or one or more task-specific intents.

A computer-implemented method for dynamically generating output in response to user input through interconnected data retrieval and processing may be provided. The computer-implemented method may be performed by one or more local or remote processors of a computing system in communication with one or more local or remote data sources. The computer-implemented method may include: (1) receiving, by the one or more processors, a request from a user device, wherein the request includes a specified task or a query; (2) utilizing, by the one or more processors, a large language model (LLM) to process the request to determine a request purpose; (3) transmitting, by the one or more processors, data corresponding to the request purpose to a retrieval augmented generation (RAG) model; (4) receiving, by the one or more processors, relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, and/or (iv) one or more generative software systems; (5) transmitting, by the one or more processors, the relevant data to a LLM data deconfliction model; (6) utilizing, by the one or more processors, the LLM data deconfliction model to processes the relevant data to reconcile, filter, or resolve conflicting or redundant information of the relevant data; (7) generating, by the one or more processors, the output based upon the relevant data, wherein the output is dynamically generated using the one or more generative software systems; and/or (8) outputting, by the one or more processors, the output to a user interface of the user device.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for generative AI, ChatGPT, InstructGPT bot, Codex bot, or Google Bard bot.

In certain aspects, determining the request purpose may include (i) processing, by the one or more processors, via the LLM, the request to extract one or more keywords or one or more phrases indicative of a user intent; and/or (ii) applying, by the one or more processors, via the LLM, one or more natural language processing (NLP) techniques to classify the one or more keywords or the one or more phrases into one or more categories.

Additionally or alternatively, the one or more categories may include one or more general knowledge topics, one or more specialized domains, or one or more task-specific intents.

In various embodiments, the RAG model may communicates with the LLM to retrieve general-purpose knowledge by analyzing historical training data to identify the relevant data. The retrieval process may be based upon the one or more user-defined configurations that specifies one or more of (i) data type priority, (ii) data source priority, (iii) retrieval depth, and/or (iv) one or more criteria for contextual filtering.

In certain embodiments, the RAG model may communicate with the one or more SLMs trained upon one or more datasets corresponding to one or more specific domains to retrieve domain-specific knowledge corresponding to the request. The retrieval process may be based upon the one or more user-defined configurations that specifies one or more of (i) selection of SLM based upon training focus, (ii) inclusion or exclusion of specific dataset categories, and/or (iii) one or more criteria for evaluating relevance and context of retrieved domain-specific knowledge.

In some embodiments, the one or more dynamic data streams associated with the one or more interconnected systems may include (i) telemetry data from one or more software-defined vehicles, (ii) sensor data from one or more smart houses, (iii) personalized user data from one or more smart devices, and/or (iv) multi-dimensional data stream from one or more interconnected databases. The selection and a configuration of the one or more dynamic data streams may be based upon the one or more user-defined configurations that specifies one or more of (i) selection of specific data streams from the one or more interconnected systems, (ii) customization of integration of the one or more interconnected systems into the RAG model, and/or (iii) parameters for filtering or normalization of selected data streams.

Additionally or alternatively, the telemetry data may include an operational status, one or more diagnostics, and/or one or more environmental conditions. The sensor data may include temperature data, one or more security camera feeds, and/or energy consumption. The personalized user data may include one or more health metrics, location information, and/or one or more user activity logs. The multi-dimensional data stream may include structured data, one or more real-time data feeds, historical data, business intelligence data, and/or user generated data.

In certain aspects, the one or more interconnected databases may include one or more of (i) a public cloud storage, (ii) a private cloud storage, (iii) a subscription-based proprietary database, and/or (iv) an open source knowledge graph and ontologies.

In various embodiments, the RAG model may communicate with a live web connection to perform real-time web scraping, indexing, or querying of the one or more interconnected databases to supplement the relevant data.

In certain embodiments, the one or more generative software systems may include (i) a code generation tool to generate one or more executable programming scripts, (ii) a text generation tool to generate one or more human-readable textual responses, (iii) an image generation tool to create a visual representation based upon the relevant data, (iv) a video generation tool to produce one or more animated or real-world video outputs, (v) an audio generation tool to generate one or more aural responses, and/or (vi) a media generation tool to develop one or more websites, one or more applications, or one or more interactive environments, and at least one generative software system is selected and configured based upon the one or more user-defined configurations that specifies the at least one generative software system to use for generating the output.

In some embodiments, the LLM data deconfliction model reconciling the conflicting information may include (i) assigning, by the one or more processors, via the LLM data deconfliction model, one or more confidence scores to one or more data elements associated with the relevant data based upon (a) a data source, (b) recency and relevance of the data to the purpose of the request, or (c) consistency of the data with corroborating information retrieved from the one or more data sources; (ii) ranking, by the one or more processors, via the LLM data deconfliction model, the one or more data elements based upon the one or more confidence scores; and/or (iii) filtering, by the one or more processors, via the LLM data deconfliction model, the one or more data elements with confidence scores to remove at least one of the one or more data elements with a confidence score below a predetermined threshold.

In certain aspects, the LLM data deconfliction model resolving the redundant information may include (i) identifying, by the one or more processors, via the LLM data deconfliction model, one or more semantically equivalent data points through a similarity scoring process, wherein a natural language processing (NLP) technique analyzes a contextual meaning of each data point and assigns a similarity score based upon a semantic proximity of one or more data points, and wherein the one or more data points with high similarity score are grouped together and considered equivalent for the purpose of the request; and/or (ii) filtering, by the one or more processors, via the LLM data deconfliction model, duplicate or overlapping data based upon the similarity score.

In certain aspects, the data corresponding to the request purpose may include one or more of (i) metadata associated with the request, (ii) historical user interaction data relevant to the request, (iii) data identifying domain or category of the request, and/or (iv) contextual parameters associated with the request.

A computer system for dynamically generating output in response to user input through interconnected data retrieval and processing may be provided. The computer system may include one or more processors of a computing system, and at least one non-transitory computer readable medium storing instructions which, when executed by the one or more processors, cause the one or more processors to perform operations. The computer system may perform operations including (1) receiving a request from a user device, wherein the request includes a specified task or a query; (2) utilizing a large language model (LLM) to process the request to determine a request purpose; (3) transmitting data corresponding to the request purpose to a retrieval augmented generation (RAG) model; (4) receiving relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, and/or (iv) one or more generative software systems; (5) transmitting the relevant data to a LLM data deconfliction model; (6) utilizing the LLM data deconfliction model to processes the relevant data to reconcile, filter, or resolve conflicting or redundant information of the relevant data; (7) generating the output based upon the relevant data, wherein the output is dynamically generated using the one or more generative software systems; and/or (8) outputting the output to a user interface of the user device.

In certain aspects, determining the request purpose may include (i) processing via the LLM, the request to extract one or more keywords or one or more phrases indicative of a user intent; and/or (ii) applying via the LLM, one or more natural language processing (NLP) techniques to classify the one or more keywords or the one or more phrases into one or more categories. The one or more categories may include one or more general knowledge topics, one or more specialized domains, or one or more task-specific intents.

In some embodiments, the RAG model may communicate with the LLM to retrieve general-purpose knowledge by analyzing historical training data to identify the relevant data, and wherein the retrieval process may be based upon the one or more user-defined configurations that specifies one or more of (i) data type priority, (ii) data source priority, (iii) retrieval depth, and/or (iv) one or more criteria for contextual filtering.

In certain embodiments, the RAG model may communicate with the one or more SLMs trained upon one or more datasets corresponding to one or more specific domains to retrieve domain-specific knowledge corresponding to the request. The retrieval process may be based upon the one or more user-defined configurations that specifies one or more of (i) selection of SLM based upon training focus, (ii) inclusion or exclusion of specific dataset categories, and/or (iii) one or more criteria for evaluating relevance and context of retrieved domain-specific knowledge.

In various embodiments, the one or more dynamic data streams associated with the one or more interconnected systems may include (i) telemetry data from one or more software-defined vehicles, (ii) sensor data from one or more smart houses, (iii) personalized user data from one or more smart devices, and/or (iv) multi-dimensional data stream from one or more interconnected databases. A selection and a configuration of the one or more dynamic data streams may be based upon the one or more user-defined configurations that specifies one or more of (i) selection of specific data streams from the one or more interconnected systems, (ii) customization of integration of the one or more interconnected systems into the RAG model, and/or (iii) parameters for filtering or normalization of selected data streams.

A non-transitory computer readable medium for dynamically generating output in response to user input through interconnected data retrieval and processing may be provided. The non-transitory computer readable medium may store instructions which, when executed by one or more processors, cause the one or more processors to perform operations. The one or more processors may perform operations including (1) receiving a request from a user device, wherein the request includes a specified task or a query; (2) utilizing a large language model (LLM) to process the request to determine a request purpose; (3) transmitting data corresponding to the request purpose to a retrieval augmented generation (RAG) model; (4) receiving relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, and/or (iv) one or more generative software systems; (5) transmitting the relevant data to a LLM data deconfliction model; (6) utilizing the LLM data deconfliction model to processes the relevant data to reconcile, filter, or resolve conflicting or redundant information of the relevant data; (7) generating the output based upon the relevant data, wherein the output is dynamically generated using the one or more generative software systems; and/or (8) outputting the output to a user interface of the user device.

In some embodiments, determining the request purpose may include (i) processing via the LLM, the request to extract one or more keywords or one or more phrases indicative of a user intent; and/or (ii) applying via the LLM, one or more natural language processing (NLP) techniques to classify the one or more keywords or the one or more phrases into one or more categories. The one or more categories may include one or more general knowledge topics, one or more specialized domains, or one or more task-specific intents.

### Additional Considerations

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

The present embodiments envision collecting and analyzing user or customer data, such as mobile device data, vehicle, smart or autonomous data, vehicle telematics data, home telematics data, smart home data, smart appliance data, etc. associated with the user or customer devices or computing devices. Such data may be collected and analyzed once the user or customer affirmatively opts into a program, such as a customer loyalty or rewards program, or the customer otherwise affirmatively consents to data being generated by their devices being utilized, collected, and/or analyzed.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied upon a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate upon a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for dynamically generating output in response to user input through interconnected data retrieval and processing, the computer-implemented method performed by one or more processors of a computing system in communication with one or more data sources, the computer-implemented method comprising:
receiving, by the one or more processors, a request from a user device, wherein the request includes a specified task or a query;
utilizing, by the one or more processors, a large language model (LLM) to process the request to determine a request purpose;
transmitting, by the one or more processors, data corresponding to the request purpose to a retrieval augmented generation (RAG) model;
receiving, by the one or more processors, relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, or (iv) one or more generative software systems;
transmitting, by the one or more processors, the relevant data to a LLM data deconfliction model;
utilizing, by the one or more processors, the LLM data deconfliction model to processes the relevant data to reconcile, filter, or resolve conflicting or redundant information of the relevant data;
generating, by the one or more processors, the output based upon the relevant data, wherein the output is dynamically generated using the one or more generative software systems; and
outputting, by the one or more processors, the output to a user interface of the user device.

2. The computer-implemented method of claim 1, wherein determining the request purpose, further comprises:
processing, by the one or more processors, via the LLM, the request to extract one or more keywords or one or more phrases indicative of a user intent; and
applying, by the one or more processors, via the LLM, one or more natural language processing (NLP) techniques to classify the one or more keywords or the one or more phrases into one or more categories.

3. The computer-implemented method of claim 2, wherein the one or more categories include one or more general knowledge topics, one or more specialized domains, or one or more task-specific intents.

4. The computer-implemented method of claim 1, wherein the RAG model communicates with the LLM to retrieve general-purpose knowledge by analyzing historical training data to identify the relevant data, and wherein the retrieval process is based upon the one or more user-defined configurations that specifies one or more of (i) data type priority, (ii) data source priority, (iii) retrieval depth, or (iv) one or more criteria for contextual filtering.

5. The computer-implemented method of claim 1, wherein the RAG model communicates with the one or more SLMs trained upon one or more datasets corresponding to one or more specific domains to retrieve domain-specific knowledge corresponding to the request, and wherein the retrieval process is based upon the one or more user-defined configurations that specifies one or more of (i) selection of SLM based upon training focus, (ii) inclusion or exclusion of specific dataset categories, or (iii) one or more criteria for evaluating relevance and context of retrieved domain-specific knowledge.

6. The computer-implemented method of claim 1, wherein the one or more dynamic data streams associated with the one or more interconnected systems includes (i) telemetry data from one or more software-defined vehicles, (ii) sensor data from one or more smart houses, (iii) personalized user data from one or more smart devices, or (iv) multi-dimensional data stream from one or more interconnected databases, and wherein a selection and a configuration of the one or more dynamic data streams is based upon the one or more user-defined configurations that specifies one or more of (i) selection of specific data streams from the one or more interconnected systems, (ii) customization of integration of the one or more interconnected systems into the RAG model, or (iii) parameters for filtering or normalization of selected data streams.

7. The computer-implemented method of claim 6, wherein the telemetry data includes an operational status, one or more diagnostics, or one or more environmental conditions, wherein the sensor data includes temperature data, one or more security camera feeds, or energy consumption, wherein the personalized user data includes one or more health metrics, location information, or one or more user activity logs, and wherein the multi-dimensional data stream includes structured data, one or more real-time data feeds, historical data, business intelligence data, or user generated data.

8. The computer-implemented method of claim 6, wherein the one or more interconnected databases include one or more of (i) a public cloud storage, (ii) a private cloud storage, (iii) a subscription-based proprietary database, or (iv) an open source knowledge graph and ontologies.

9. The computer-implemented method of claim 6, wherein the RAG model communicates with a live web connection to perform real-time web scraping, indexing, or querying of the one or more interconnected databases to supplement the relevant data.

10. The computer-implemented method of claim 1, wherein the one or more generative software systems include (i) a code generation tool to generate one or more executable programming scripts, (ii) a text generation tool to generate one or more human-readable textual responses, (iii) an image generation tool to create a visual representation based upon the relevant data, (iv) a video generation tool to produce one or more animated or real-world video outputs, (v) an audio generation tool to generate one or more aural responses, or (vi) a media generation tool to develop one or more websites, one or more applications, or one or more interactive environments, and at least one generative software system is selected and configured based upon the one or more user-defined configurations that specifies the at least one generative software system to use for generating the output.

11. The computer-implemented method of claim 1, wherein the LLM data deconfliction model reconciling the conflicting information, further comprises:
assigning, by the one or more processors, via the LLM data deconfliction model, one or more confidence scores to one or more data elements associated with the relevant data based upon (i) a data source, (ii) recency and relevance of the data to the purpose of the request, or (iii) consistency of the data with corroborating information retrieved from the one or more data sources;
ranking, by the one or more processors, via the LLM data deconfliction model, the one or more data elements based upon the one or more confidence scores; and
filtering, by the one or more processors, via the LLM data deconfliction model, the one or more data elements with confidence scores to remove at least one of the one or more data elements with a confidence score below a predetermined threshold.

12. The computer-implemented method of claim 1, wherein the LLM data deconfliction model resolving the redundant information, further comprises:
identifying, by the one or more processors, via the LLM data deconfliction model, one or more semantically equivalent data points through a similarity scoring process, wherein a natural language processing (NLP) technique analyzes a contextual meaning of each data point and assigns a similarity score based upon a semantic proximity of one or more data points, and wherein the one or more data points with high similarity score are grouped together and considered equivalent for the purpose of the request; and
filtering, by the one or more processors, via the LLM data deconfliction model, duplicate or overlapping data based upon the similarity score.

13. The computer-implemented method of claim 1, wherein the data corresponding to the request purpose includes one or more of (i) metadata associated with the request, (ii) historical user interaction data relevant to the request, (iii) data identifying domain or category of the request, or (iv) contextual parameters associated with the request.

14. A system for dynamically generating output in response to user input through interconnected data retrieval and processing, comprising:
one or more processors of a computing system; and
at least one non-transitory computer readable medium storing instructions which, when executed by the one or more processors, cause the one or more processors to perform operations comprising:
receiving a request from a user device, wherein the request includes a specified task or a query;
utilizing a large language model (LLM) to process the request to determine a request purpose;
transmitting data corresponding to the request purpose to a retrieval augmented generation (RAG) model;
receiving relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, or (iv) one or more generative software systems;
transmitting the relevant data to a LLM data deconfliction model;
utilizing the LLM data deconfliction model to processes the relevant data to reconcile, filter, or resolve conflicting or redundant information of the relevant data;
generating the output based upon the relevant data, wherein the output is dynamically generated using the one or more generative software systems; and
outputting the output to a user interface of the user device.

15. The system of claim 14, wherein determining the request purpose, further comprises:
processing via the LLM, the request to extract one or more keywords or one or more phrases indicative of a user intent; and
applying via the LLM, one or more natural language processing (NLP) techniques to classify the one or more keywords or the one or more phrases into one or more categories, wherein the one or more categories include one or more general knowledge topics, one or more specialized domains, or one or more task-specific intents.

16. The system of claim 14, wherein the RAG model communicates with the LLM to retrieve general-purpose knowledge by analyzing historical training data to identify the relevant data, and wherein the retrieval process is based upon the one or more user-defined configurations that specifies one or more of (i) data type priority, (ii) data source priority, (iii) retrieval depth, or (iv) one or more criteria for contextual filtering.

17. The system of claim 14, wherein the RAG model communicates with the one or more SLMs trained upon one or more datasets corresponding to one or more specific domains to retrieve domain-specific knowledge corresponding to the request, and wherein the retrieval process is based upon the one or more user-defined configurations that specifies one or more of (i) selection of SLM based upon training focus, (ii) inclusion or exclusion of specific dataset categories, or (iii) one or more criteria for evaluating relevance and context of retrieved domain-specific knowledge.

18. The system of claim 14, wherein the one or more dynamic data streams associated with the one or more interconnected systems includes (i) telemetry data from one or more software-defined vehicles, (ii) sensor data from one or more smart houses, (iii) personalized user data from one or more smart devices, or (iv) multi-dimensional data stream from one or more interconnected databases, and wherein a selection and a configuration of the one or more dynamic data streams is based upon the one or more user-defined configurations that specifies one or more of (i) selection of specific data streams from the one or more interconnected systems, (ii) customization of integration of the one or more interconnected systems into the RAG model, or (iii) parameters for filtering or normalization of selected data streams.

19. A non-transitory computer readable medium for dynamically generating output in response to user input through interconnected data retrieval and processing, the non-transitory computer readable medium storing instructions which, when executed by one or more processors of a computing system, cause the one or more processors to perform operations comprising:
receiving a request from a user device, wherein the request includes a specified task or a query;
utilizing a large language model (LLM) to process the request to determine a request purpose;
transmitting data corresponding to the request purpose to a retrieval augmented generation (RAG) model;
receiving relevant data associated with the request purpose from the RAG model, wherein the RAG model retrieves the relevant data based upon one or more user-defined configurations from (i) the LLM, (ii) one or more small language models (SLMs), (iii) one or more dynamic data streams associated with one or more interconnected systems, or (iv) one or more generative software systems;
transmitting the relevant data to a LLM data deconfliction model;
utilizing the LLM data deconfliction model to processes the relevant data to reconcile, filter, or resolve conflicting or redundant information of the relevant data;
generating the output based upon the relevant data, wherein the output is dynamically generated using the one or more generative software systems; and
outputting the output to a user interface of the user device.

20. The non-transitory computer readable medium of claim 19, wherein determining the request purpose, further comprises:
processing via the LLM, the request to extract one or more keywords or one or more phrases indicative of a user intent; and
applying via the LLM, one or more natural language processing (NLP) techniques to classify the one or more keywords or the one or more phrases into one or more categories, wherein the one or more categories include one or more general knowledge topics, one or more specialized domains, or one or more task-specific intents.
